(19) United States
(12) Patent Application Publication
(10) Pub. No.: US 2017/0227971 A1
(43) Pub. Date: Aug. 10, 2017

(54) AUTONOMOUS TRAVEL MANAGEMENT APPARATUS, SERVER, AND AUTONOMOUS TRAVEL MANAGEMENT METHOD

(71) Applicant: MITSUBISHI ELECTRIC CORPORATION, Tokyo (JP)

(72) Inventors: Mitsuo SHIMOTANI, Tokyo (JP); Hidekazu ARITA, Tokyo (JP); Kenji TAKADA, Hyogo (JP)

(73) Assignee: MITSUBISHI ELECTRIC CORPORATION, Tokyo (JP)

(21) Appl. No.: 15/329,208

(22) PCT Filed: Sep. 5, 2014
(86) PCT No.: PCT/JP2014/073493

§ 371 Date: Jan. 25, 2017

(51) Int. Cl. G05D 1/02; G01C 21/34; B60W 30/16; B60W 30/18; B60W 30/12; B60W 40/06

(52) U.S. Cl. CPC G05D 1/0285; B60W 30/12; B60W 40/06; B60W 30/16; B60W 30/18163; G01C 21/3461

(57) ABSTRACT

Infrastructure clarity of a planned section that is a road section included in a planned travel route is specified based on infrastructure clarity information. The infrastructure clarity is clarity of a road infrastructure that is used as a detection object by a lane detection apparatus. The infrastructure clarity information is information recording the infrastructure clarity for a plurality of lanes for one-way traffic on a per road section basis. A road link used in a map database is adopted as the road section. Control contents of autonomous travel in the planned travel route are set based on the infrastructure clarity of the planned section and an autonomy level condition. The autonomy level condition is a condition by which control contents at a higher level are selected among a plurality of autonomy levels as the infrastructure clarity becomes higher.

### TECHNICAL FIELD

The present invention relates to autonomous travel control of a vehicle.

### BACKGROUND ART

As a type of autonomous travel control of a vehicle, there is known lane keeping control of controlling a vehicle so that the vehicle does not veer off the lane. According to the lane keeping control, a lane has to be detected. According to Patent Documents 1 to 3, a white line, which is a marking line on a road surface, is used for lane detection. Specifically, image processing for detecting a marking line is applied on an image of a road surface captured from a vehicle.

Moreover, Patent Document 1 describes a technology for appropriately detecting a lane even if a marking line is a broken line. Also, Patent Document 2 describes control of allowing veering from a lane in a case where an obstacle is detected by a radar device. Moreover, Patent Document 3 describes a technology for registering information about a spot where lane keeping control is not possible due to fading or dirt on a white line on a road where an own vehicle is to travel, and for notifying a driver in advance of a lane keeping control disabled spot based on the registered information.

Furthermore, Patent Document 4 describes a technology for detecting a lane by detecting a magnetic field distribution generated by a magnetic marker buried in a road.

### PRIOR ART DOCUMENTS

### Patent Documents

Patent Document 1: Japanese Patent Application Laid-Open No. 2006-151123

Patent Document 2: Japanese Patent Application Laid-Open No. 2012-79118

Patent Document 3: Japanese Patent Application Laid-Open No. 2004-126888

Patent Document 4: Japanese Patent Application Laid-Open No. 2001-167388

### SUMMARY OF INVENTION

### Problems to be Solved by the Invention

The technologies of Patent Documents 1 to 4 merely switch between two states of autonomous travel on and autonomous travel off. Thus, it is conceivable that a driver feels the burden of driving at the time of switching of the state, especially, from the autonomous travel on to autonomous travel off. As a result, implementing the autonomous travel function may actually increase the burden of driving.

The present invention has its object to provide a technology for reducing the burden of driving related to autonomous travel control.

### Means for Solving the Problems

An autonomous travel management system according to the present invention includes a planned route specification unit for specifying a planned travel route for a target vehicle of travel control, an information storage unit for storing infrastructure clarity information recording infrastructure clarity for each road section, the infrastructure clarity being clarity of a road infrastructure that is used as a detection object by a lane detection system provided to the target vehicle, an infrastructure clarity specification unit for performing an infrastructure clarity specification process for specifying, based on the infrastructure clarity information, the infrastructure clarity of a planned section that is the road section included in the planned travel route, and a travel control management unit for performing an autonomous travel setting process for setting control contents of autonomous travel in the planned travel route based on the infrastructure clarity of the planned section, and for performing the autonomous travel setting process according to an autonomy level condition by which control contents at a higher level are selected among a plurality of autonomy levels as the infrastructure clarity becomes higher.

### Effects of the Invention

According to an autonomous travel management system of the present invention, autonomous travel is controlled based on a plurality of autonomy levels. Accordingly, the contents of travel control may be prevented from drastically changing. Therefore, the burden of driving felt by a driver in relation to autonomous travel control may be reduced.

The objects, features and advantages of the present invention will be made even more clear by the following detailed description and the appended drawings.

### BRIEF DESCRIPTION OF DRAWINGS

FIG. 1 is a block diagram of an autonomous travel control system according to a first embodiment.

FIG. 2 is a block diagram of an autonomous travel management system according to the first embodiment.

FIG. 3 is a diagram describing white line clarity information (infrastructure clarity information) according to the first embodiment.

FIG. 4 is a diagram describing a planned travel route according to the first embodiment.

FIG. 5 is a diagram describing a white line clarity specification process (infrastructure clarity specification process) according to the first embodiment.

FIG. 6 is a diagram describing an autonomous travel setting process according to the first embodiment.

FIG. 7 is a diagram describing a result of the autonomous travel setting process according to the first embodiment.

FIG. 8 is a flow chart describing an operation of the autonomous travel control system according to the first embodiment.

FIG. 9 is a diagram describing the autonomous travel setting process according to the first embodiment (a case where magnetic infrastructure is used for lane detection).

FIG. 10 is a diagram describing an autonomous travel setting process according to a second embodiment.

FIG. 11 is a diagram describing a result of the autonomous travel setting process according to the second embodiment.

FIG. 12 is a diagram describing a timing of switching of control contents according to a third embodiment.

FIG. 13 is a diagram describing a frequent change section according to a fourth embodiment.

FIG. 14 is a diagram describing an autonomous travel setting process according to a fifth embodiment.

FIG. 15 is a diagram describing an autonomous travel setting process according to the fifth embodiment (a case where cancellation of an autonomous travel mode is included).

FIG. 16 is a block diagram describing a case where an autonomous travel control system coordinates with a server, according to the fifth embodiment.

FIG. 17 is a block diagram of an autonomous travel management system according to a sixth embodiment.

FIG. 18 is a block diagram of an autonomous travel management system according to a seventh embodiment.

FIG. 19 is a diagram of an example display of a map image according to the seventh embodiment.

FIG. 20 is a flow chart describing an operation of an autonomous travel control system according to an eighth embodiment.

FIG. 21 is a flow chart describing the operation of the autonomous travel control system according to the eighth embodiment.

FIG. 22 is a flow chart describing the operation of the autonomous travel control system according to the eighth embodiment.

FIG. 23 is a block diagram of an autonomous travel management system according to a ninth embodiment.

FIG. 24 is a block diagram of an autonomous travel management system according to a tenth embodiment.

FIG. 25 is a diagram describing clarity related information according to the tenth embodiment.

FIG. 26 is a block diagram of an autonomous travel management system according to an eleventh embodiment.

FIG. 27 is a block diagram of an autonomous travel control system according to a twelfth embodiment.

FIG. 28 is a block diagram of an autonomous travel control system according to the twelfth embodiment.

FIG. 29 is a block diagram of an autonomous travel control system according to the twelfth embodiment.

FIG. 30 is a block diagram of an autonomous travel control system according to the twelfth embodiment.

FIG. 31 is a block diagram of an autonomous travel control system according to the twelfth embodiment.

### DESCRIPTION OF EMBODIMENTS

### First Embodiment

<Autonomous Travel Control System 10>

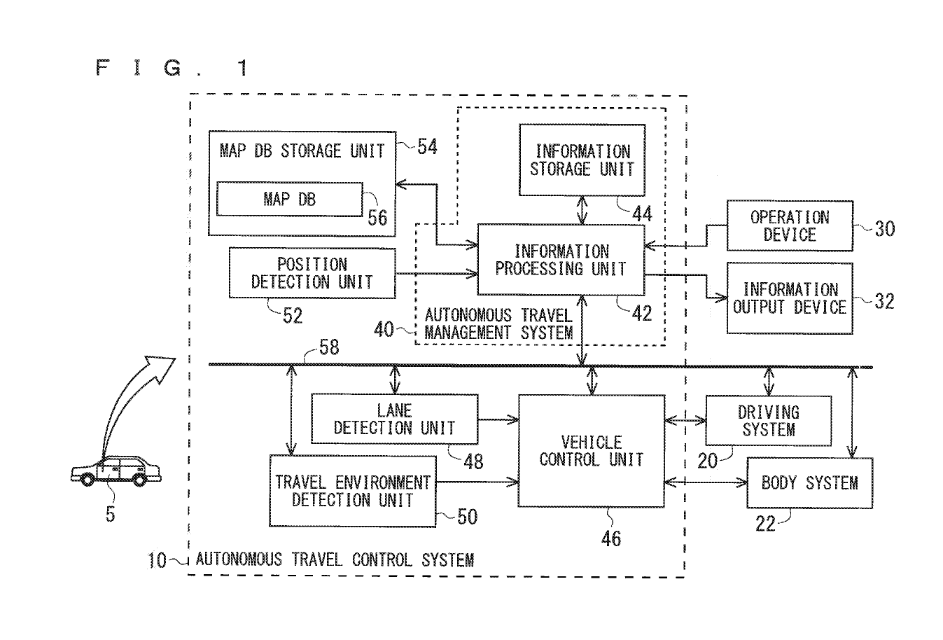

FIG. 1 shows a block diagram of an autonomous travel control system 10 according to a first embodiment. In FIG. 1, the entire autonomous travel control system 10 is installed in a target vehicle 5 of travel control. In the following, the target vehicle 5 may also be referred to as an own vehicle 5.

The autonomous travel control system 10 determines the contents of travel control, and controls a driving system 20 of the target vehicle 5 according to the determined control contents. The driving system 20 is a device group for realizing basic functions for traveling, i.e. acceleration, braking and steering. The driving system 20 includes a power generation source (at least one of an engine and a motor), a power transmission device, a braking device, a steering device, and the like.

Autonomous speed control is realized by the autonomous travel control system 10 controlling acceleration and braking. The autonomous speed control is applied to inter-vehicle distance control, constant speed traveling control, and the like. Also, autonomous steering control is realized by the autonomous travel control system 10 controlling steering. The autonomous steering control is applied to lane keeping control, passing control, and the like.

The target vehicle 5 includes a body system 22, which is a device group not directly related to traveling. The body system 22 includes wipers, lamps, turn signals, door opening/closing devices, window opening/closing devices, and the like. However, turn signals are used for passing control, for example. The devices to be used at the time of execution of basic functions are to be controlled by the autonomous travel control system 10.

In FIG. 1, the autonomous travel control system 10 is connected to an operation device 30 and an information output device 32. The operation device 30 is a device for a user (for example, a driver) of the target vehicle 5 to operate the autonomous travel control system 10. The information output device 32 is a device for providing information to the user from the autonomous travel control system 10. The information output device 32 is configured by at least one of a display for visually outputting information and an acoustic device for acoustically outputting information. Additionally, an information terminal, such as a mobile phone, a smartphone or a tablet terminal, may also be used as a device integrating the operation device 30 and the information output device 32.

The autonomous travel control system 10 includes an autonomous travel management system 40, a vehicle control unit 46, a lane detection unit 48, a travel environment detection unit 50, a position detection unit 52, and a map database storage unit 54. Additionally, a database may also be referred to as a DB. The autonomous travel management system 40 is connected, via an in-vehicle local area network (LAN) 58, to the vehicle control unit 46, the lane detection unit 48, the travel environment detection unit 50, the driving system 20, and the body system 22.

The autonomous travel management system 40 performs various processes related to autonomous travel control, such as a process for determining control contents. The autonomous travel management system 40 includes an information processing unit 42 and an information storage unit 44. The information processing unit 42 is configured from a microprocessor and a semiconductor memory. Various functions of the information processing unit 42 are realized by the microprocessor executing programs in the semiconductor memory. The information storage unit 44 is configured by a storage device such as a semiconductor memory or a hard disk device, and stores various pieces of information related to autonomous travel management. Details of the autonomous travel management system 40 will be given later. Additionally, the information processing unit 42 may perform processes other than autonomous travel control, such as a process related to navigation.

The vehicle control unit 46 is a system (a vehicle control system) for controlling the driving system 20 based on control contents determined by the autonomous travel management system 40. Additionally, the vehicle control unit 46 may also control the body system 22, such as at the time of controlling a turn signal in relation to passing control.

The vehicle control unit 46 acquires, according to control contents, basic control information, which is information to be used for execution of the control contents. The basic control information is information about the state of the driving system 20 (information about the speed, the steering angle, and the like). Alternatively, the basic control information is information of a detection result of the lane detection unit 48, the travel environment detection unit 50, or the position detection unit 52. Alternatively, the basic control information is map information.

For example, with respect to lane keeping control, pieces of information about detection results of the lane detection unit 48 and the position detection unit 52 are included in the basic control information. The vehicle control unit 46 determines, based on the basic control information, the lane where the own vehicle 5 is traveling and the position of the own vehicle 5 in the lane. Also, with respect to inter-vehicle distance control, an inter-vehicle distance measured by the travel environment detection unit 50 is included in the basic control information.

The lane detection unit 48 is a system (a lane detection system) for detecting a lane using a road infrastructure as a clue. In the following, an example is cited where a white line drawn on the road surface to divide lanes is the road infrastructure used as a clue. Additionally, the shape of the white line (a solid line, a broken line, or a double line) is not particularly limited. Moreover, taking into account that a white line is a typical example of a marking line, and that a marking line is generally referred to as a white line, a yellow marking line (a so-called yellow line) is also included as the white line.

The lane detection unit 48 detects the position of a lane by capturing the front of the own vehicle 5 by a camera and performing image analysis for white line detection on the captured image. Additionally, it is also possible to use a plurality of cameras, or to capture other directions in addition to the front.

The travel environment detection unit 50 is a system (a travel environment detection system) for detecting information about the travel environment of the own vehicle 5. The travel environment detection unit 50 acquires information about the presence or the size of an object, the relative position or the distance to an object, or the like by emitting, as a reference wave, a laser beam from the own vehicle 5 to the front and observing the reflected light. The reference wave may also be laser, a millimeter wave, a microwave, or an ultrasonic wave. Scattering of the reference wave may be observed instead of or in addition to the reflection of the reference wave. The reference wave may also be emitted in other than the front direction.

The travel environment detection unit 50 may be configured to perform image analysis for object detection on an image captured from the own vehicle 5 by a camera. Alternatively, if the travel environment detection unit 50 is configured by an inter-vehicle communication device, information about the relative position or the distance to another vehicle, or the like may be acquired based on information that is received by inter-vehicle communication.

As described above, the travel environment detection unit 50 may be configured according to various methods. Also, by mounting the travel environment detection unit 50 of a plurality of methods on the target vehicle 5, various objects may be simultaneously detected. Moreover, according to the image analysis method described above, by recognizing a road marking line in a captured image, instead of or in addition to detecting an object, the contents of the marking line (the legal speed, prohibition of stopping, or the like) may be acquired. If the travel environment detection unit 50 is configured as a vehicle-to-infrastructure communication device, road marking information may be acquired by vehicle-to-infrastructure communication.

The position detection unit 52 is a system (a position detection system) for detecting the current position of the own vehicle 5. For example, the position detection unit 52 receives a global positioning system (GPS) radio wave, and calculates position information from the received signal. It is also possible to adopt, instead of or in addition to the GPS, a method for determining position information from information from an accelerometer, a gyro sensor, a vehicle speed signal, or the like.

The map DB storage unit 54 is configured as a storage device such as a semiconductor memory or a hard disk device, and stores a map DB 56 in which pieces of map information are systematically organized and managed.

<Autonomous Travel Management System 40>

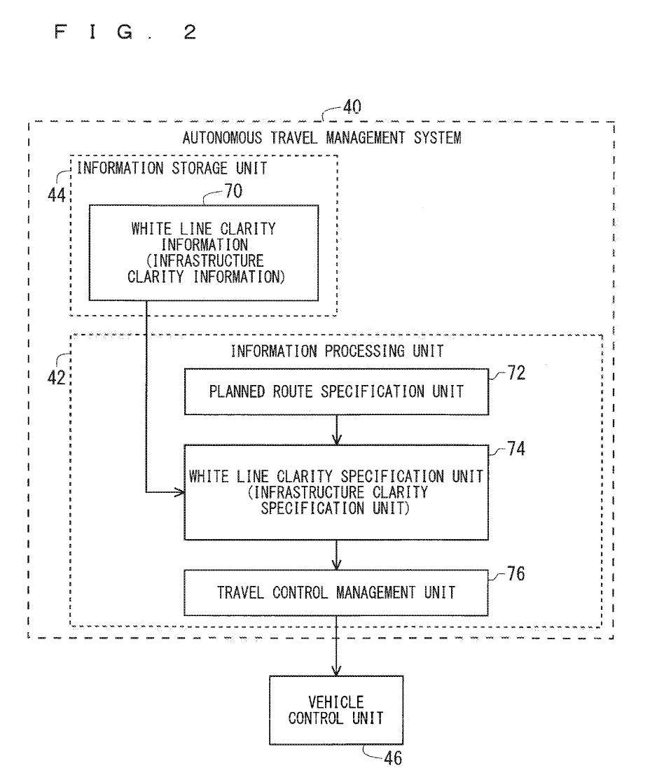

FIG. 2 shows a block diagram of the autonomous travel management system 40. As shown in. FIG. 2, infrastructure clarity information 70 is stored in the information storage unit 44. Infrastructure clarity, which is the degree of clarity of a road infrastructure used as a detection object by the lane detection unit 48, is recorded as the infrastructure clarity information 70. As described above, the lane detection unit 48 detects a white line on a road with respect to lane detection, and thus, the infrastructure clarity will be referred to as white line clarity in the following.

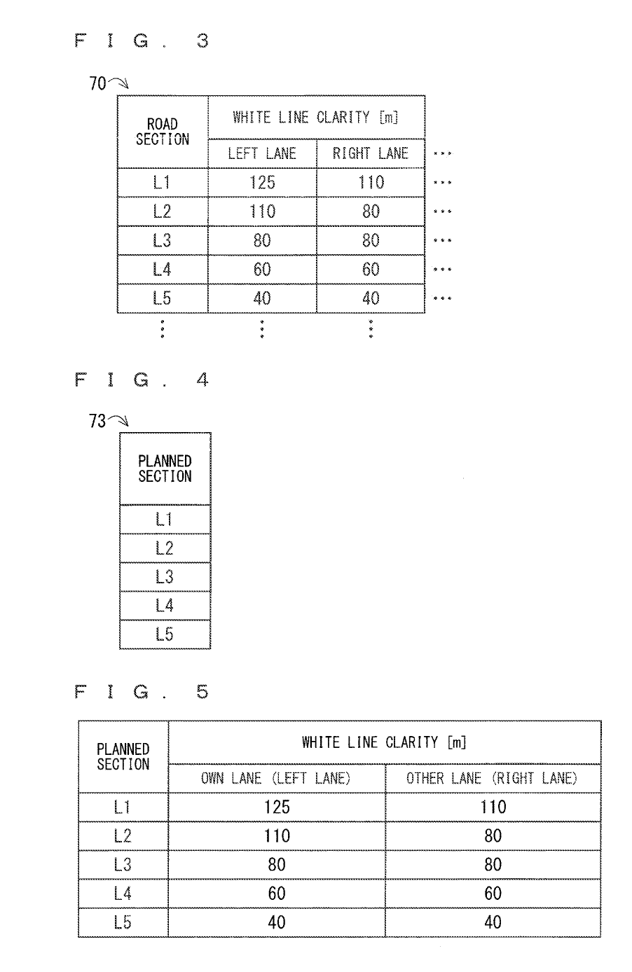

FIG. 3 shows an explanatory diagram of the white line clarity information 70. As shown in FIG. 3, the white line clarity information 70 records the white line clarity for each road section. FIG. 3 illustrates information about two lanes for one-way traffic. The road sections in the white line clarity information 70 are the same as road sections (so-called road links) adopted for management of a road network in the map DB 56. In FIG. 3, L1, L2, and so forth are identifiers (so-called IDs) of the road sections.

The white line clarity is indicated by the distance of a white line (in other words, a road infrastructure distance) that extends from a traveling spot in the traveling direction and that can be detected by the lane detection unit 48. A white line that can be detected by the lane detection unit 48 refers to a white line having a clarity that allows detection by the lane detection unit 48. In other words, a white line which cannot be detected by the lane detection unit 48 because of reduced clarity due to fading, dirt or the like is excluded. Referring to the white line clarity of the left lane in FIG. 3, the lowest white line clarity in the entire section of the road section L1 is 125 meters. That is, in the road section L1, the white line clarity of 125 meters or more is constantly provided. Likewise, the lowest white line clarity in the entire section of the road section L2 is 110 meters, and the white line clarity of 110 meters or more is constantly provided in the road section L2.

Moreover, in the above, the white line clarity is set assuming that, if the white line is even partially in a detection disabled state due to a missing part, fading or the like, the white line is broken at the spot. However, the white line clarity may also be set by assuming that, even if a very short portion is in the detection disabled state, if the white line may be recognized as being continuous by a general white line estimation process, the white line is not broken. For example, in the case of a straight or gently curved road, estimation of a white line is possible even if the white line is missing or faded for several meters, and the white line clarity does not have to be set to a short distance. This depends also on the white line detection method, and a plurality of white line clarities according to respective types of the white line detection method may be recorded for each road section.

Referring back to FIG. 2, the information processing unit 42 includes a planned route specification unit 72, a white line clarity specification unit (in other words, an infrastructure clarity specification unit) 74, and a travel control management unit 76.

The planned route specification unit 72 specifies a planned travel route of the target vehicle 5. Specifically, the planned route specification unit 72 refers to and searches through the map DB 56 for a route from a first spot to a second spot, and determines an obtained route as the planned travel route. The first spot and the second spot may be designated by a user in advance, and in that case, position information about the first spot and the second spot may be acquired in advance based on the designated contents of the user and the map DB 56. If the first spot is the current location, position information of the current location may be acquired by the position detection unit 52. Even if the second spot is not designated (in the case where a navigation function is off, for example), the planned route specification unit 72 may provisionally set one or a plurality of second spots. For example, a spot which is a spot on a route extending forward from the current location and which is separate from the current location by a distance that is set in advance may be set as the second spot. A provisional second spot may be revised as appropriated.

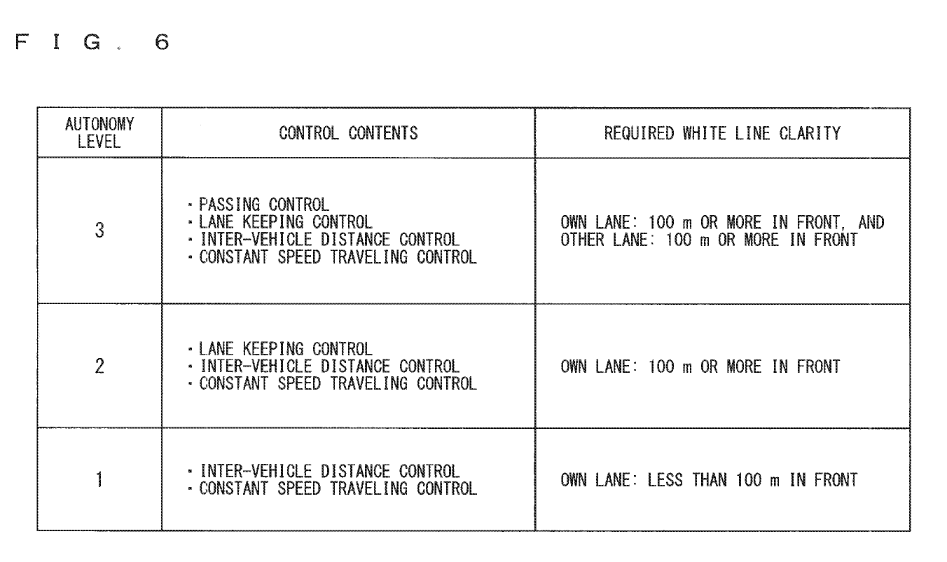

Here, as shown in FIG. 4, it is assumed that a planned travel route 73 including road sections L1, L2, L3, L4 and L5 is specified. A road section included in the planned travel route 73 may be sometimes referred to as a planned section.

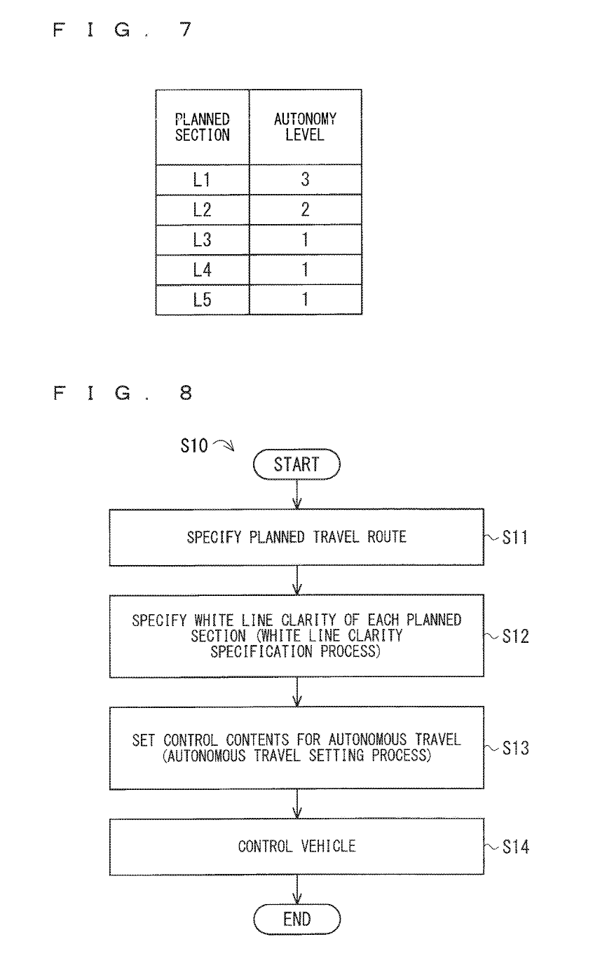

The white line clarity specification unit 74 performs a white line clarity specification process (in other words, an infrastructure clarity specification process), which is a process for specifying the white line clarity of a planned section based on the white line clarity information 70. FIG. 5 shows the white line clarity specified for the planned travel route 73 in FIG. 4 based on the white line clarity information 70 in FIG. 3. In FIG. 5, it is assumed that the target vehicle 5 is traveling on the left lane.

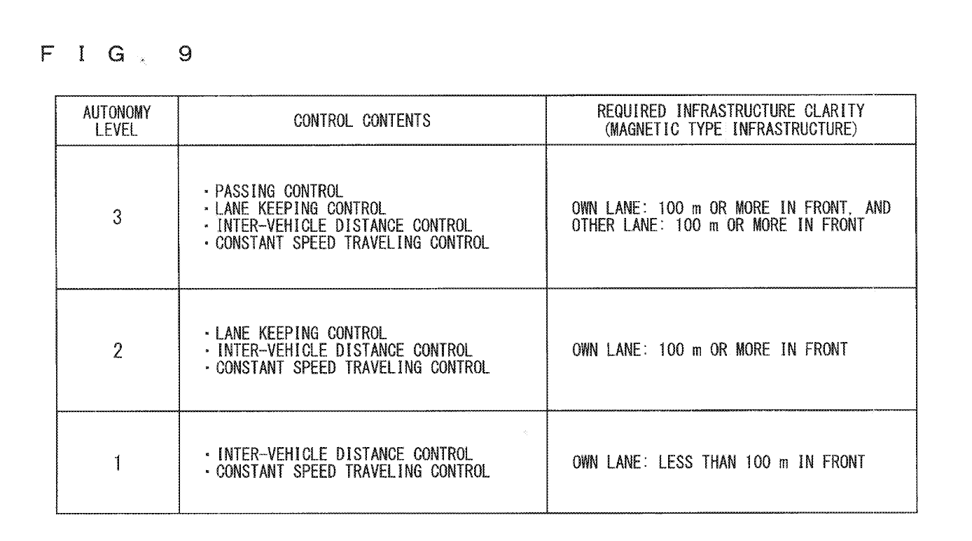

Referring back to FIG. 2, the travel control management unit 76 performs an autonomous travel setting process, which is a process for setting the control contents of autonomous travel on the planned travel route 73 based on the white line clarity of the planned sections. In the autonomous travel setting process, a plurality of autonomy levels are defined in advance, and an autonomy level for a planned section is selected according to the white line clarity of the planned section. That is, control contents of autonomous travel are set for each planned section according to an autonomy level condition by which higher level control contents are selected as the white line clarity becomes higher. The autonomous travel setting process will be described with reference to FIG. 6.

In FIG. 6, levels 1 to 3 are defined as the autonomy levels for travel control. A greater value of a level indicates a higher autonomy level. Inter-vehicle distance control and constant speed traveling control are assigned as the control contents at the lowest level 1. Lane keeping control is assigned as the control contents at the level 2, in addition to the control contents at the level 1. Passing control is assigned as the control contents at the highest level 3, in addition to travel control contents at the level 2. That is, the autonomy level becomes higher as the control contents include a greater number of types of control selected among the inter-vehicle distance control, the constant speed traveling control, the lane keeping control, and the passing control.

Additionally, at the level 3, a driving operation is hardly performed by the driver. At the level 2, the driver has to operate the steering wheel and the accelerator pedal at the time of passing. At the level 1, the driver has to operate the steering wheel.

The white line clarity is associated with each of the levels 1 to 3. That is, the white line clarity is used as a condition for adopting the control contents at a level. Specifically, to adopt the control contents at the highest level 3, it is required that the white line clarity of the own lane is 100 meters or more in the front and that the white line clarity of the other lane is 100 meters or more in the front. Regarding the level 2, it is required that the white line clarity of the own lane is 100 meters or more in the front, but a requirement is not defined regarding the white line clarity of the other lane. Regarding the level 1, that the white line clarity of the own lane is less than 100 meters in the front is defined as the condition for adoption.

Additionally, in FIG. 6, the lower limit of the white line clarity is not defined for the lowest level 1. In the case where a lower limit is provided, an autonomous travel mode is automatically switched off in a planned section below the lower limit, and a manual travel mode is reached. In other words, the autonomous travel mode based on FIG. 6 is switched off by a user performing a predetermined operation.

In FIG. 6, in addition to the autonomy level condition by which control contents at a higher level are selected as the white line clarity becomes higher, an autonomous steering condition is incorporated. The autonomous steering condition is a condition by which control contents including autonomous steering control that uses the lane detection unit 48 are selected for a planned section where the white line clarity satisfies an autonomous steering standard. Specifically, in FIG. 6, the autonomous steering standard defines that the white line clarity of the own lane should be 100 meters or more in the front. Also, the control contents including the autonomous steering control are defined for the levels 3 and 2.

Furthermore, in FIG. 6, an autonomous steering level condition by which the control contents including autonomous steering control at a higher level are selected as the white line clarity becomes higher is incorporated. Specifically, the level 3 including the lane keeping control and the passing control is higher than the level 2 including the lane keeping control but not including the passing control, and the level 3 requires higher white line clarity.

The contents in FIG. 6 are incorporated in the program for the autonomous travel setting process by using a condition determination formula or the like. However, the control contents of autonomous travel may also be set by storing the contents in FIG. 6 in the information storage unit 44 and by the travel control management unit 76 referring to the contents.

FIG. 7 shows the control contents (the levels thereof) set based on FIGS. 3 to 6.

<Operation>

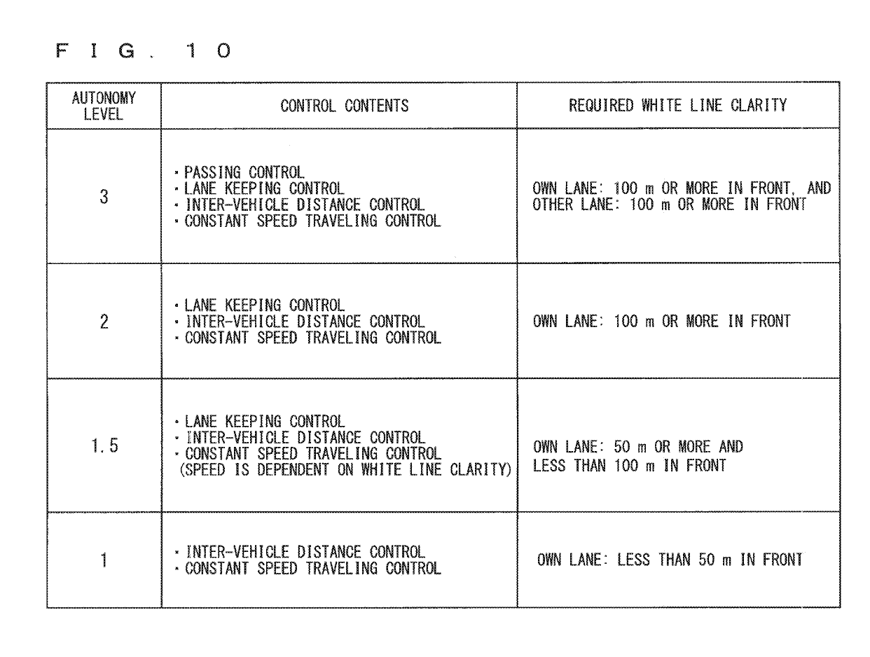

FIG. 8 shows a flow chart describing an operation of the autonomous travel control system 10. According to an operation flow S10 in FIG. 8, the planned route specification unit 72 specifies a planned travel route 73 in step S11. Next, in step S12, the white line clarity specification unit 74 performs the white line clarity specification process, and in step S13, the travel control management unit 76 performs the autonomous travel setting process. Then, in step S14, the travel control management unit 76 gives the vehicle control unit 46 the control contents for each planned section, and the vehicle control unit 46 thus controls traveling of the target vehicle 5 according to the control contents. Switching of the control contents is to be performed at a timing of switching of the planned section, that is, at a timing of reaching a switching spot of the planned section. The operation flow S10 is performed every time the planned travel route 73 is changed. Alternatively, the operation flow S10 may be performed every specific period of time.

<Effects>

According to the first embodiment, autonomous travel is controlled based on a plurality of autonomy levels. Accordingly, the contents of travel control may be prevented from drastically changing. Therefore, the burden of driving felt by the driver in relation to the autonomous travel control may be reduced. Additionally, it is sufficient if the number of autonomy levels is at least two, and the effects described above may be obtained even if one of the levels 1 to 3 in FIG. 6 is omitted, for example.

<Other Examples of Road Infrastructure>

A case has been described above where the road infrastructure used by the lane detection unit 48 for lane detection is a white line on the road, and the position of a lane is detected by performing image analysis for white line detection on a captured image. A road infrastructure which is detected by performing image analysis for road infrastructure detection on a captured image will be referred to as a capture type infrastructure.

The color of a capture type infrastructure may be a color in the visible range other than white. Furthermore, if an infrared camera or an ultraviolet camera is used by the lane detection unit 48, for example, the color of the capture type infrastructure may be a color outside the visible range. The shape of the capture type infrastructure may be any of a solid line, a broken line, a double line, a character, a sign and the like. That is, various road markings drawn on the road surface may be used as capture type infrastructures. Moreover, the capture type infrastructure may be drawn by applying a paint on the road surface. Alternatively, the capture type infrastructure may be drawn by changing the color of the pavement material.

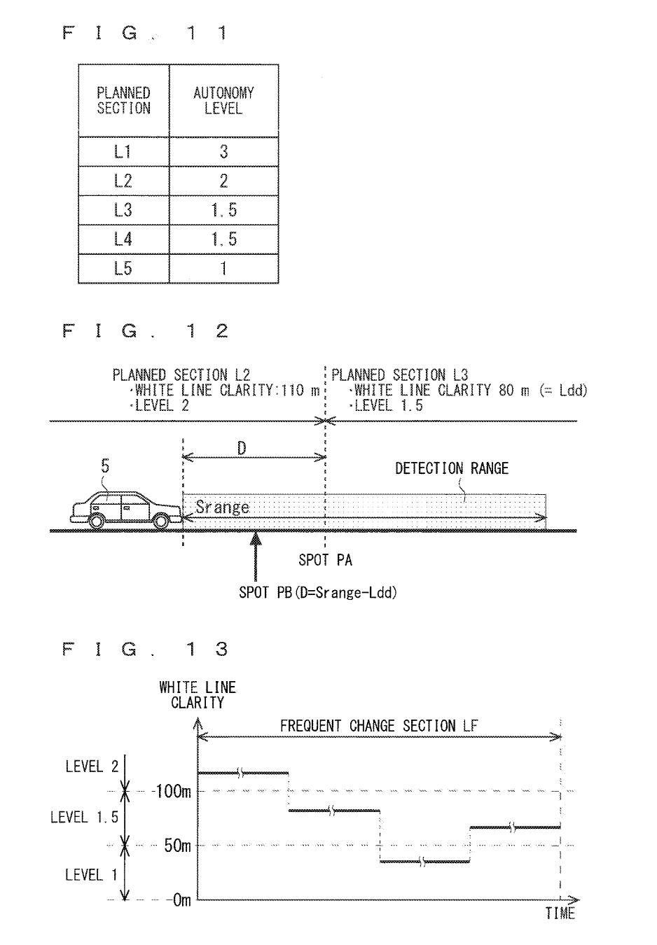

It is also possible to use one of a magnetic type infrastructure (a so-called magnetic marker) that generates magnetism, a radio wave type infrastructure that emits radio waves, a light emission type infrastructure that emits light, and an acoustic type infrastructure that emits sound. In the case of the magnetic type infrastructure, the lane detection unit 48 is configured by using a magnetic sensor. In the case of the radio wave type infrastructure, the lane detection unit 48 is configured by using a radio receiver. In the case of the light emission type infrastructure, the lane detection unit 48 is configured by using an optical sensor. Alternatively, a method of detecting a light emitting part from an image captured by a camera may be used, and in this case, the light emission type infrastructure may be categorized as the capture type infrastructure. In the case of the acoustic type infrastructure, the lane detection unit 48 is configured by using a sound collector. For example, with respect to a case of using the magnetic type infrastructure, FIG. 9 shows an explanatory diagram of an autonomous travel setting process corresponding to FIG. 6.

All the types of road infrastructures are to be installed on a road, but the road infrastructures may also be installed on a wall or the like along a road.

### Second Embodiment

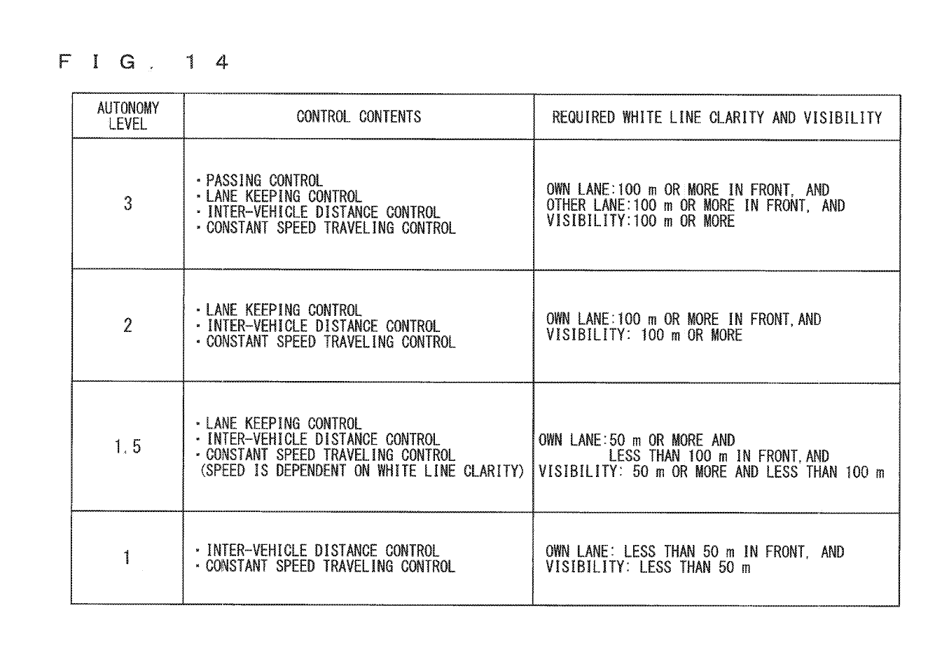

In a second embodiment, a case where the autonomous travel control system 10 according to the first embodiment performs a different autonomous travel setting process from FIG. 6 will be described with reference to FIG. 10. In FIG. 10, a level 1.5 which is higher than the level 1 and lower than the level 2 is added. The expression “level 1.5” is used so as to facilitate comparison between FIG. 10 and FIG. 6, but the four levels 1, 1.5, 2 and 3 in FIG. 10 may also be referred to as levels 1, 2, 3 and 4.

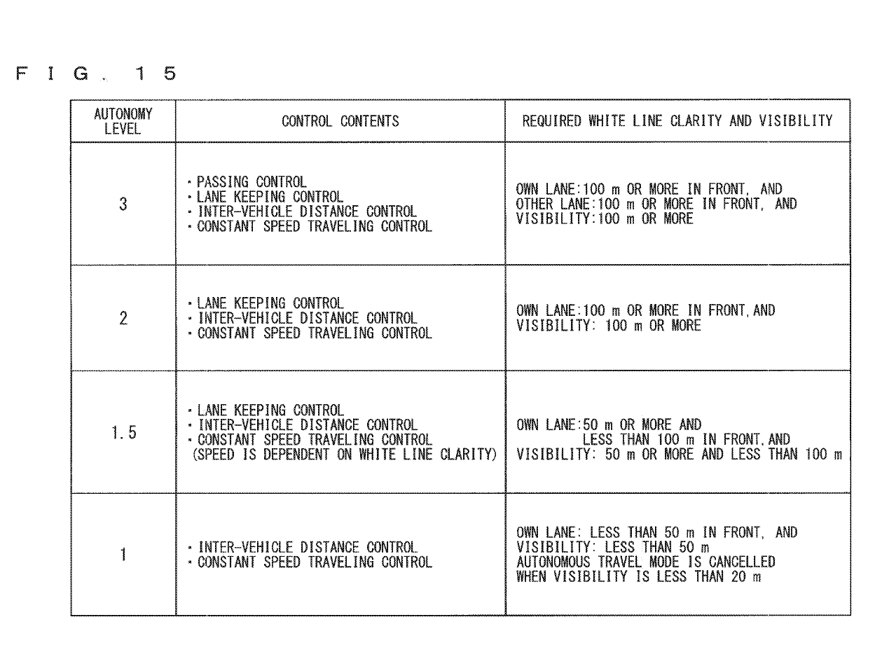

At the level 1.5, the same control contents as the level 2 are assigned, but a constant speed (in other words, an upper limit speed) applied to the constant speed traveling control is changed according to the white line clarity. That is, the constant speed to be applied to a planned section is set to be lower as the white line clarity of the planned section is lower. Also, to adopt the level 1.5, it is required that the white line clarity of the own lane is 50 meters or more and less than 100 meters in the front. Additionally, in FIG. 10, the condition for adoption of the level 1 is changed to the white line clarity, of the own lane, of less than 50 meters in the front. The levels 2 and 3 are the same as in FIG. 6. FIG. 11 shows the control contents (the levels thereof) set based on FIGS. 3 to 5 and FIG. 10.

At the level 1.5, the constant speed for a planned section where the white line clarity is 70 meters is set to be lower than the constant speed for a planned section where the white line clarity is 90 meters. In the same manner, the constant speed for a planned section where the white line clarity is 50 meters is set to be lower than the constant speed for the planed section where the white line clarity is 70 meters.

The constant speed to be applied at the level 1.5 is set from the standpoint of a stopping distance, for example. The stopping distance here is the distance from a spot where the driver decides to apply the brake to a spot where the vehicle actually stops. The stopping distance is determined by totaling the reaction distance and the braking distance. The reaction distance is the distance traveled by a vehicle between a time point when the driver decides to apply the brake and a time point when the brake starts to work. The braking distance is the distance traveled by a vehicle between the time point when the brake starts to work and a time point when the vehicle stops. The stopping distance is dependent on the vehicle speed, and is longer as the vehicle speed is higher.

A user setting speed set by the user as the constant speed at the time of constant speed traveling control is given as Vset [km/h], and the stopping distance in the case of traveling at the user setting speed is given as Lstop [m]. Also, the white line clarity is given as Ld [m], and the speed at which the stopping distance is Ld is given as Vld [km/h]. The travel control management unit 76 selects, as the constant speed for a planned section where the white line clarity is Ld, one of the user setting speed Vset and the speed Vld which is based on the white line clarity (Ld) and the stopping distance. Selection is performed based on comparison between Ld and Lstop. That is, in the case of Ld≧Lstop, Vset is selected, and in the case of Ld<Lstop, Vld is selected. However, it is necessary to comply with the legal speed (given as Vreg [km/h]). Accordingly, in the case of Ld≧Lstop, the lower of Vset and Vreg is set as the constant speed. On the other hand, in the case of Ld<Lstop, the lower of Vld and Vreg is set as the constant speed.

For example, it is assumed that the user setting speed Vset is set to 80 km/h for a road where the legal speed Vreg is 80 km/h. The stopping distance Lstop corresponding to this Vset is given as 75 meters. In this case, the user setting speed Vset (=80 km/h) is set as the constant speed for a planned section where the white line clarity Ld is 75 meters or more. A case where the white line clarity Ld is less than 75 meters, such as Ld==60 meters, will be considered. If the speed Vld at which the stopping distance is Ld (=60 meters) is 70 km/h, the constant speed for this planned section is set to Vld.

As described above, the stopping distance is dependent on the vehicle speed. The relationship between the stopping distance and the vehicle speed is prepared in advance in a format (such as a mathematical expression or a database) that is usable by the travel control management unit 76. Additionally, various pieces of data are published regarding the relationship between the stopping distance and the vehicle speed, and the published data may be utilized. Also, influential factors other than the vehicle speed, such as the states of the road surface and the tires, may be taken into account, and the travel environment detection unit 50 for acquiring information about the influential factors is provided.

Furthermore, the legal speed is recorded in the map DB 56, and the travel control management unit 76 is to acquire information about the legal speed from the map DB 56. Alternatively, with the travel environment detection unit 50 of the image analysis method, the legal speed may be recognized from the road marking in a captured image. Alternatively, with the travel environment detection unit 50 configured by a vehicle-to-infrastructure communication device, road marking information may be acquired by vehicle-to-infrastructure communication.

According to the second embodiment, the contents of travel control may be further prevented from drastically changing, by speed adjustment for the constant speed traveling control. Accordingly, the burden of driving may be further reduced.

### Third Embodiment

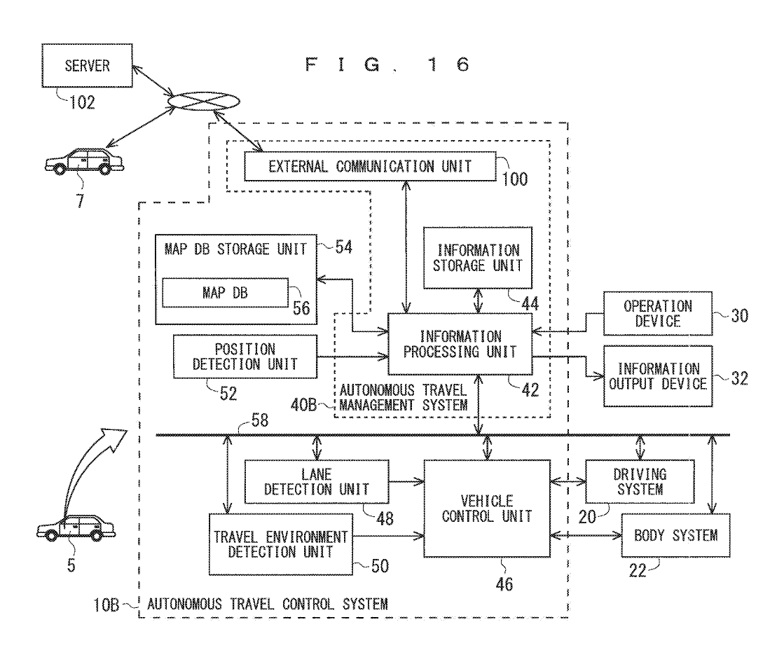

In the first and the second embodiments, switching of the control contents is performed at a timing of reaching a switching spot for planned sections. FIG. 12 shows a timing of switching of control contents, according to a third embodiment. FIG. 12 shows a situation in which the target vehicle 5 is to enter the planned section L3 from the planned section L2. Referring to FIGS. 5, 10 and 11, the white line clarity of the planned section L2 is 110 meters, and the level of the planned section L2 is 2. Also, the white line clarity of the planned section L3 is 80 meters, and the level of the planned section L3 is 1.5.

A situation in which a detection range (in other words, a detection target distance) Srange of the lane detection unit 48 in the planned section L2 (that is, at the level 2) extends across a switching spot PA for the planed sections L2 and L3 as shown in FIG. 12 will be considered. If the length of the detection range Srange (given as 100 meters) in the planned section L3 is longer than the white line clarity (80 meters) of the planned section L3, the lane detection unit 48 cannot perceive a white line amounting to the detection range Srange for the planned section L2 (that is, the level 2). Accordingly, it is desirable that the control contents for the planned section L2 (that is, the level 2) are ended and the control contents for the planned section L3 (that is, the level 1.5) are started before such a situation is reached.

As described above, the detection range of the lane detection unit 48 in the planned section L2 is given as Srange [m]. Also, the white line clarity of the planned section L3 is given as Ldd [m]. Moreover, the distance between the current position of the target vehicle 5 in the planned section L2 and a start spot of the planned section L3 is given as D [m]. In this case, at a spot PB satisfying D=Srange−Ldd, the length of the detection range Srange in the planned section L3 is equal to the white line clarity Ldd of the planned section L3. Accordingly, the travel control management unit 76 starts the control contents of the planned section L3 before D<Srange−Ldd is established (that is, before the spot PB is reached). Specifically, the control contents of the planned section L3 are started at the timing of establishment of D=Srange Ldd. Alternatively, to have a margin, the control contents of the planned section L3 may be started before the timing of establishment of D=Srange−Ldd.

The timing of switching of the control contents is adjusted not only in the case of entering from the planned section L2 to the planned section L3. That is, in the case where the white line clarity will be reduced due to entrance from a first planned section into a second planned section, it is advantageous to start the control contents of the second planned section before entrance into the second planned section.

According to the third embodiment, adjustment of the timing of switching of the control contents helps more appropriate execution of control contents. The burden of driving may thereby be reduced even more.

### Fourth Embodiment

Control contents for a case where the white line clarity changes frequently will be described in a fourth embodiment. It is assumed that a frequent change section LF (see FIG. 13), which is a section where the white line clarity changes at a frequency equal to or more than a defined frequency, is present in a planned travel route 73. The defined frequency defines that, for example, if traveling is continued at a current vehicle speed, the white line clarity is changed at a time interval of 10 minutes over an hour. In this case, a frequency equal to or more than the defined frequency means that a phenomenon where the interval of change in the white line clarity becomes 10 minutes or less occurs at least once each hour.

In the case where there is the frequent change section LF, the travel control management unit 76 applies the control contents based on the lowest white line clarity in the frequent change section LF to the entire section of the frequent change section LF in question. In the example in FIG. 13, because the lowest white line clarity of the frequent change section LF belongs to the level 1, the control contents at the level 1 are applied to the entire section of the frequent change section LF.

According to the fourth embodiment, control contents may be prevented from being switched frequently according to a frequent change in the white line clarity. The burden of driving may thereby be reduced even more.

### Fifth Embodiment

In a fifth embodiment, a case where there is an occurrence of an obstruction situation, which is a situation which may become an obstruction to execution of travel control contents, will be described. In the case where the travel control management unit 76 acquires information about an obstruction situation, the travel control management unit 76 sets the control contents based not only on the white line clarity of the planned section, but also on the obstruction situation in the planned section.

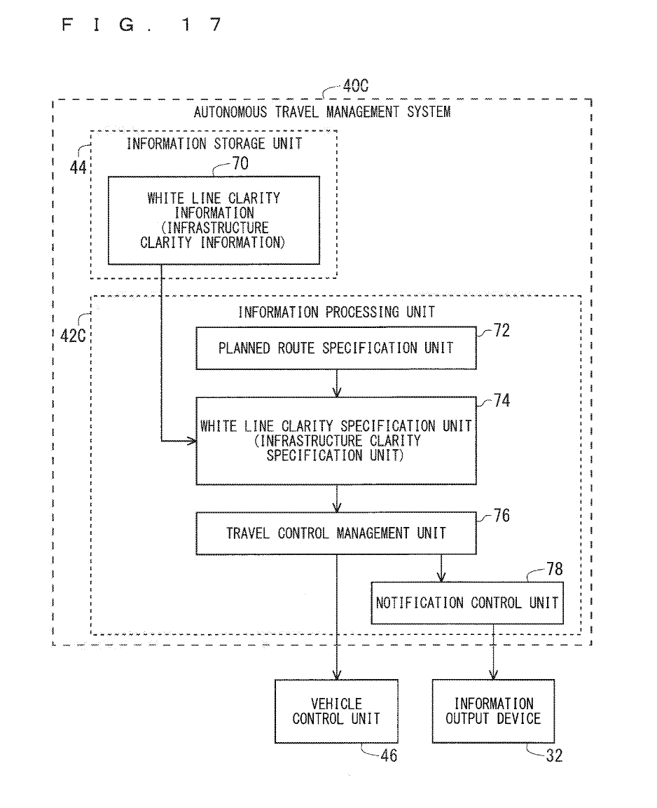

As the obstruction situation, a lane detection obstruction situation, which is a situation which may become an obstruction to lane detection by the lane detection unit 48, will be cited. More specifically, low visibility due to rain, snow, fog, suspended particulates or the like is conceivable. An explanatory diagram of an autonomous travel setting process in such a case is shown in FIG. 14. As can be seen when comparing FIG. 14 to FIG. 10, a requirement that the visibility be 100 meters or more is added to the level 3. The same can be said for the level 2. With respect to the level 1.5, a requirement that the visibility be 50 meters or more and less than 100 meters is added. With respect to the level 1, that the visibility is less than 50 meters is defined as a condition for adoption.

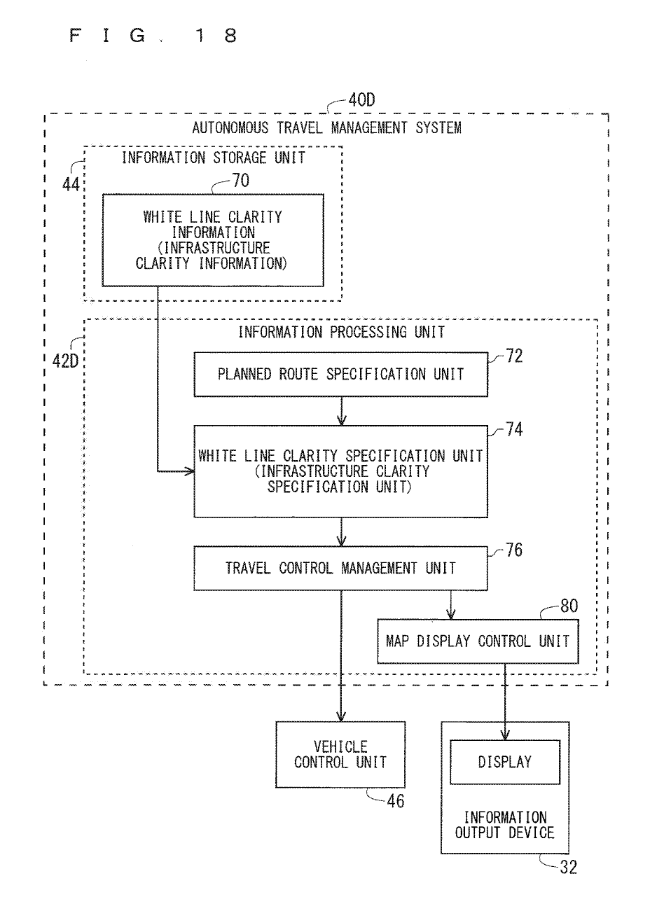

In the case where the travel control management unit 76 determines based on the obstruction situation (in this case, the lane detection obstruction situation) that autonomous travel is not suitable, the travel control management unit 76 may cancel the autonomous travel mode. An explanatory diagram of an autonomous travel setting process in such a case is shown in FIG. 15. As can be seen when comparing FIG. 15 to FIG. 14, it is defined for the lowest level 1 that the autonomous travel mode is to be cancelled in a case where the visibility is less than 20 meters. Additionally, the condition for cancelling the autonomous travel mode is not limited to such an example.

The visibility may be measured by a travel environment detection unit 50 on which a fog sensor or the like is mounted. A measurement result, that is, information about the visibility, is supplied from the travel environment detection unit 50 to the travel control management unit 76. Alternatively, a travel environment detection unit 50 configured by a vehicle-to-infrastructure communication device may acquire information about the visibility by vehicle-to-infrastructure communication.

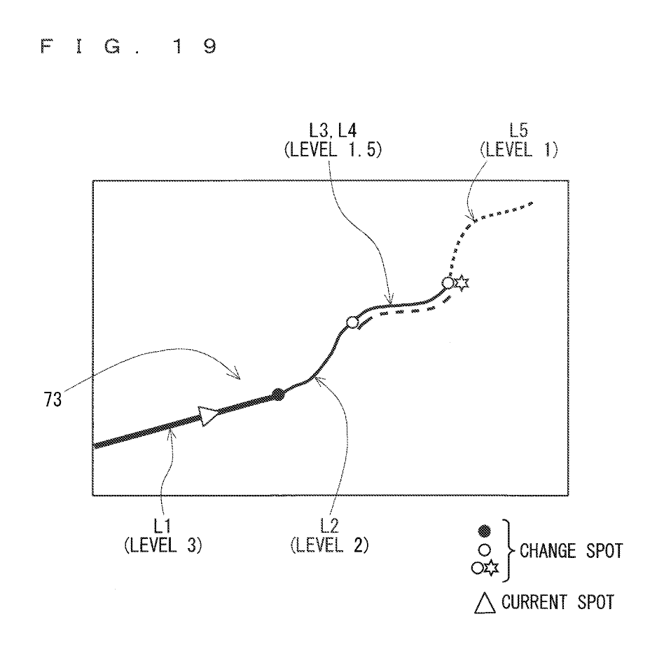

Alternatively, the travel control management unit 76 may access a server 102 via an external communication unit 100 (see FIG. 16), and acquire information about the visibility held by the server 102. Additionally, an autonomous travel management system 40B in an autonomous travel control system 10B in FIG. 16 has the configuration of the autonomous travel management system 40 described above to which the external communication unit 100 is added. The external communication unit 100 is assumed to be installed in the target vehicle 5, but an information terminal such as a mobile phone, a smartphone or a tablet terminal may alternatively be used as the external communication unit 100.

In addition to low visibility, a situation where the white line is hidden by snow is also included as the lane detection obstruction situation. Information about fallen snow may be acquired from the server 102, or by vehicle-to-infrastructure communication.

Also in the case of a road infrastructure other than the capture type infrastructure such as a white line, the control contents are set or the autonomous travel mode is cancelled based on the lane detection obstruction situation. With a magnetic type infrastructure, a radio wave type infrastructure, a light emission type infrastructure, and an acoustic type infrastructure, disturbance causes the lane detection obstruction situation. For example, in the case of the magnetic type infrastructure, disturbance is magnetic interference such as a magnetic storm. Also, in the case of the radio wave type infrastructure, the light emission type infrastructure, and the acoustic type infrastructure, an infrastructure failure such as blackout may be the cause of the lane detection obstruction situation.

The obstruction situation at the time of execution of the travel control contents is not limited to the lane detection obstruction situation. For example, when measurement of an inter-vehicle distance by the travel environment detection unit 50 is interfered with by climate or disturbance, the accuracy of measurement may be reduced or measurement is made impossible. In this case, execution of inter-vehicle distance control is obstructed.

Furthermore, a traffic obstruction situation such as an accident or a traffic jam is also included as the obstruction situation at the time of execution of the travel control contents. Information about a traffic obstruction may be acquired from a server holding such information, or may be acquired by vehicle-to-infrastructure communication.

According to the fifth embodiment, autonomous travel control according to the current situation may be realized.

### Sixth Embodiment

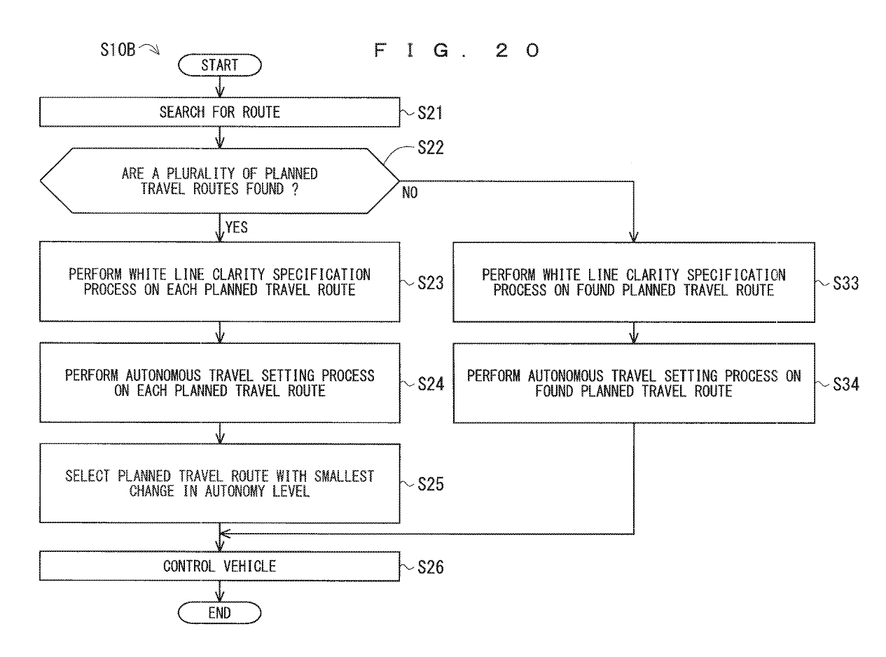

FIG. 17 shows a block diagram of an autonomous travel management system 40C according to a sixth embodiment. The autonomous travel management system 40C may be applied to the autonomous travel control systems 10, 10B described above, instead of the autonomous travel management system 40. The autonomous travel management system 40C includes an information processing unit 42C according to the sixth embodiment, and the information storage unit 44 described above. The information processing unit 42C has the configuration of the information processing unit 42 described above to which a notification control unit 78 is added.

The notification control unit 78 acquires a timing of change in the autonomy level from the travel control management unit 76, and causes the information output device 32 to output a level change notification, which is a notification that the autonomy level is to be changed. In the case where the level change notification includes a visual form such as a character or a figure, the notification control unit 78 causes the display of the information output device 32 to output the level change notification. In the case where the level change notification includes an auditory form such as sound or voice, the notification control unit 78 causes an acoustic device of the information output device 32 to output the level change notification. The notification control unit 78 outputs the level change notification at a timing before the timing of change in the autonomy level. Additionally, switching between the autonomous travel mode and the manual travel mode is also included as the change in the autonomy level.

According to the sixth embodiment, the driver may know beforehand the change in the autonomy level. Accordingly, the burden of driving may be further reduced.

### Seventh Embodiment

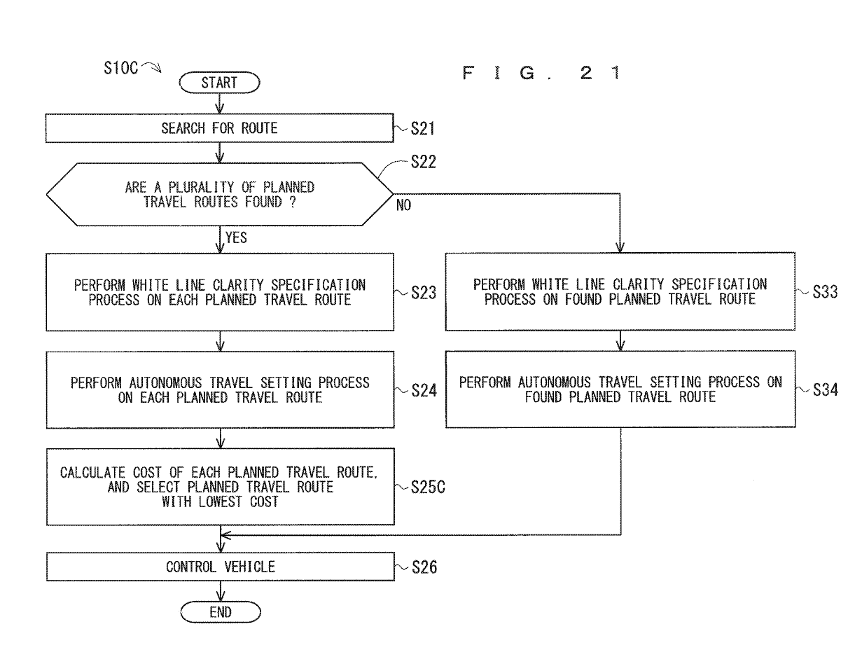

FIG. 18 shows a block diagram of an autonomous travel management system 40D according to a seventh embodiment. The autonomous travel management system 40D may be applied to the autonomous travel control systems 10, 10B described above, instead of the autonomous travel management system 40. The autonomous travel management system 40D includes an information processing unit 42D according to the seventh embodiment, and the information storage unit 44 described above. The information processing unit 42D has the configuration of the information processing unit 42 described above to which a map display control unit 80 is added.

The map display control unit 80 generates map image data for display by using the map DB 56, supplies the generated map image data to the display of the information output device 32, and thereby causes the display to display a map image. In the case where a planned travel route 73 is included in a generation target area of the map image data, the map display control unit 80 sets the display form of a planned section included in the generation target area according to the autonomy level of the planned section. At this time, the map display control unit 80 determines whether a planned travel route 73 is included in the generation target area or not, by acquiring a road section identifier (a so-called ID) of a planned section from the travel control management unit 76. Also, the map display control unit 80 acquires information about the autonomy level of the planned section from the travel control management unit 76.

FIG. 19 shows an example display of a map image. In FIG. 19, the planned section L2 at the level 2 is displayed in a display form of a standard setting, and the planned section L1 at the level 3 is thickly displayed. In the planned sections L3 and L4 at the level 1.5, the road itself is displayed in the display form of the standard setting, and a broken line is displayed along the road. The planned section L5 at the level 1 is displayed by a broken line. The display color of the road may be controlled according to the autonomy level. At this time, the color of the broken line added at the level 1.5 may be made different from the color of the road.

Furthermore, in FIG. 19, a spot of change in the autonomy level is displayed by the display form of the planned section. That is, an end spot of the planned section L1 is a level change spot, and is thus displayed with a shape of a black circle added to the end spot. The planned section L2 is displayed with a shape of a white circle added to the end spot, and the planned section L4 is displayed with shapes of a white circle and a star added to the end spot. Additionally, a black circle or the like may be added to a start spot of a planned section. Moreover, the shape or the color of a mark to be added is not limited to the examples shown in FIG. 19.

According to the seventh embodiment, the driver may know the autonomy level and a change in the autonomy level on a map image. Accordingly, the burden of driving may be further reduced.

### Eighth Embodiment

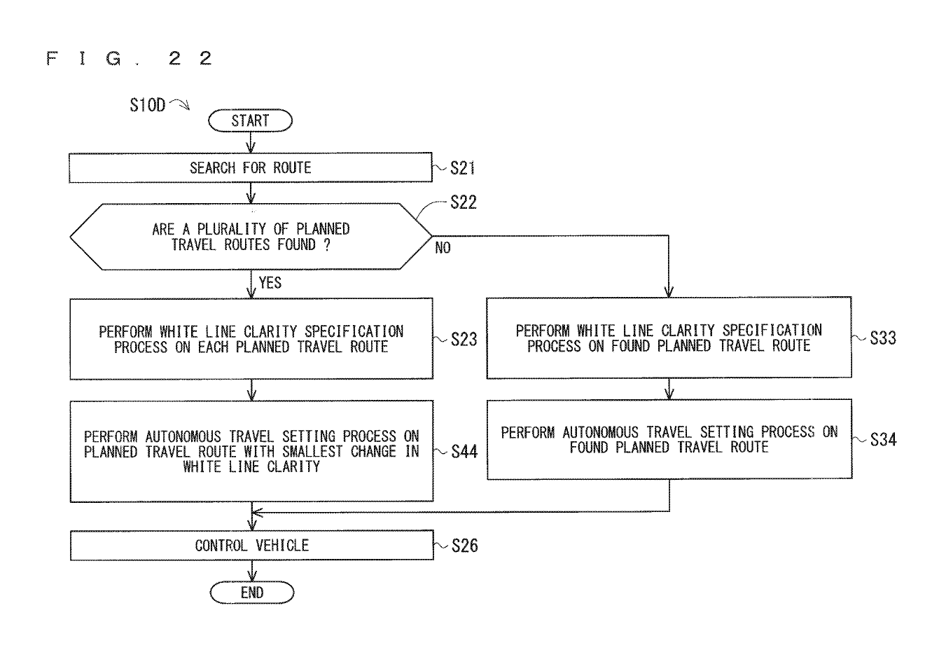

In an eighth embodiment, a case will be described where a plurality of routes are found as a planned travel route 73 by route search by the planned route specification unit 72. FIG. 20 shows a flow chart describing an operation according to the eighth embodiment. According to an operation flow S10B in FIG. 20, in step S21, the planned route specification unit 72 searches for a route so as to specify a planned travel route 73.

In the case where a plurality of planned travel routes 73 are found as a result of the route search (see step S22), the white line clarity specification unit 74 performs the white line clarity specification process on each of the plurality of found planned travel routes 73 in step S23. Next, in step S24, the travel control management unit 76 performs the autonomous travel setting process on each of the plurality of found planned travel routes 73, and in step S25, one planned travel route 73 with the smallest change in the autonomy level is selected based on the results of the autonomous travel setting process. A change in the autonomy level is determined based on at least one of the number of times of change and the change width. Then, in step S26, the travel control management unit 76 gives the vehicle control unit 46 the control contents for the selected planned travel route 73, and the vehicle control unit 46 controls traveling of the target vehicle 5 according to the control contents.

On the other hand, in the case where only one planned travel route 73 is found as a result of the route search (see step S22), steps S33, S34 the same as steps S12, S13 described above (see FIG. 8) are performed based on the found planned travel route 73. Then, step S26 is performed based on the result of the autonomous travel setting process in step S34.

According to the operation flow S10B, a route where a change in the autonomy level is suppressed may be searched. Accordingly, the burden of driving may be further reduced.

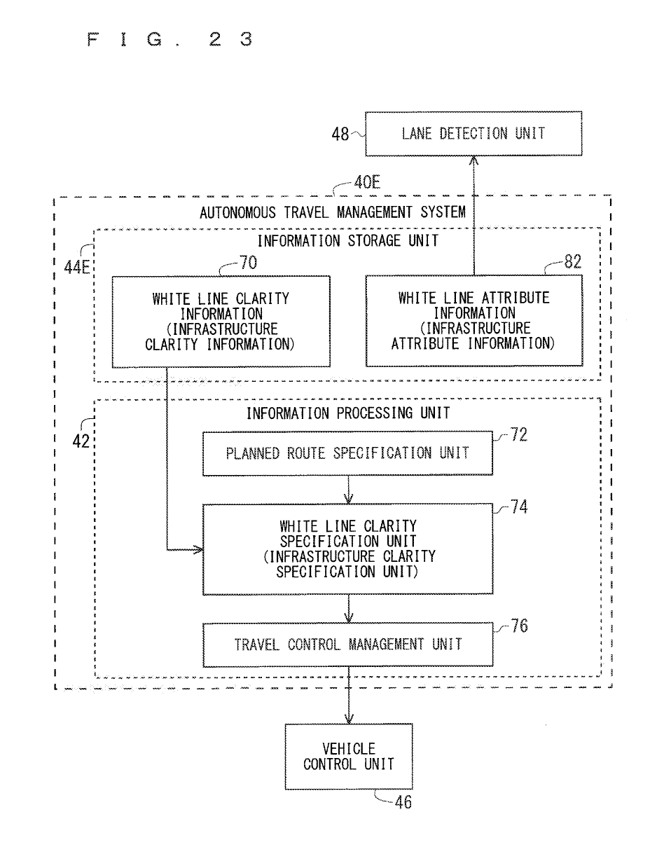

FIG. 21 shows another operation flow S10C. In the operation flow S10C, step S25 in the operation flow S10B in FIG. 20 is changed to step S25C. In step S25C, the travel control management unit 76 calculates the cost of traveling each planned travel route 73 based on the result of the autonomous travel setting process for each planned travel route 73 obtained in step S24. Then, the travel control management unit 76 selects one planned travel route 73 with the lowest cost. After step S25C, step S26 is performed.

The cost of a planned travel route 73 may be expressed by the energy cost, the amount of energy consumption, the time cost, or the like. Also, the cost of the planned travel route 73 may be expressed by combining (for example, by adding up) a plurality of types of costs.

As the cost based on the result of the autonomous travel setting process, there is a so-called link cost. Specifically, the cost of each planned section included in a planned travel route 73 may be calculated based on the speed set for the planned section by the autonomous travel setting process (that is, the constant speed at the time of constant speed traveling control), and the distance of the planned section (which may be acquired from the map DB 56). Then, the costs of the planned sections may be integrated to obtain the cost of the planned travel route 73.

Moreover, as the cost based on the result of the autonomous travel setting process, a cost defined based on a change in the autonomy level may be newly introduced. Such a cost will be referred to as an autonomy level change cost. For example, the autonomy level change cost is increased as the number of times of change in the autonomy level in the planed travel route 73 is increased.

The cost based on the result of the autonomous travel setting process may combine (for example, add up) the link cost and the autonomy level change cost. Also, a cost which is not based on the result of the autonomous travel setting process, such as a node cost (the cost at the time of passing through a node which is a link connection portion), may additionally be taken into account for selection of the planned travel route 73.

According to the operation flow S10C, a planned travel route 73 which makes a great detour may be prevented from being selected. Accordingly, the burden of driving may be further reduced.

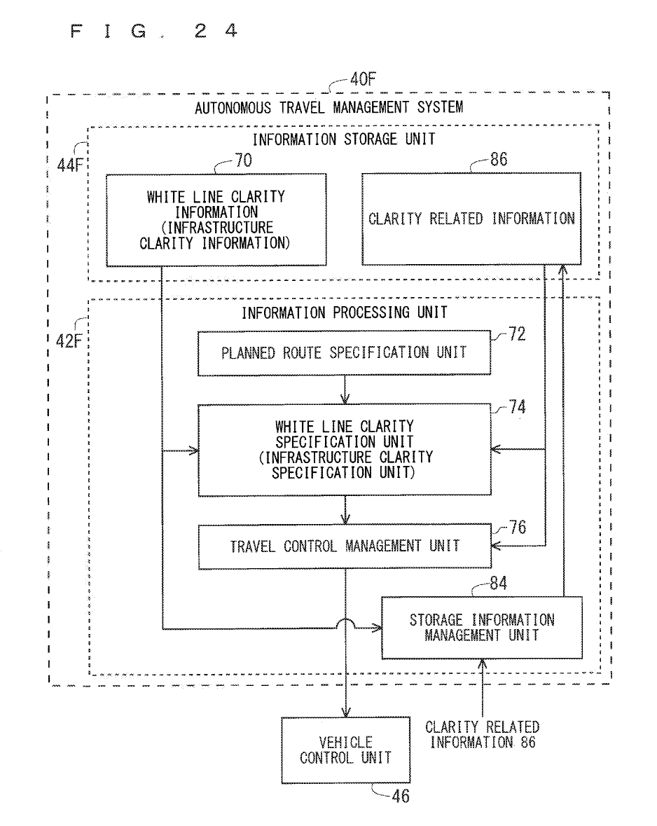

FIG. 22 shows further another operation flow S10D. In the operation flow S10D, steps S24, S25 are omitted from the operation flow S10B in FIG. 20, and step S44 is added. In step S44, the travel control management unit 76 selects one planned travel route 73 with the smallest change in the white line clarity based on the results of the white line clarity specification process in step S23, and performs the autonomous travel setting process on the selected planned travel route 73. After step S44, step S26 is performed.

According to the operation flow S10D, a route where a change in the autonomy level is suppressed may be searched. Accordingly, the burden of driving may be further reduced.

### Ninth Embodiment

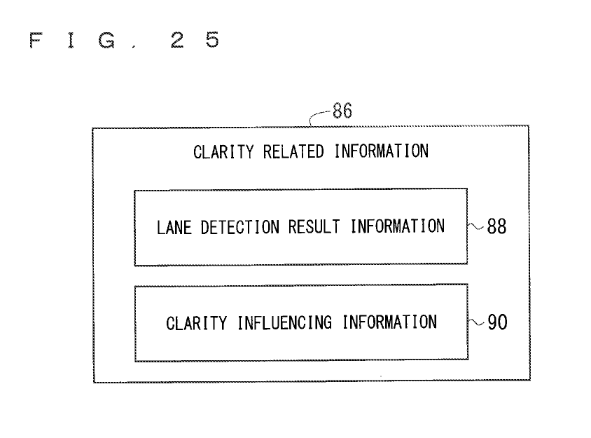

FIG. 23 shows a block diagram of an autonomous travel management system 40E according to a ninth embodiment. The autonomous travel management system 40E may be applied to the autonomous travel control systems 10, 10B described above, instead of the autonomous travel management system 40. The autonomous travel management system 40E includes the information processing unit 42 described above, and an information storage unit 44E according to the ninth embodiment. The information storage unit 44E stores, in addition to the white line clarity information 70 described above, white line attribute information (in other words, infrastructure attribute information) 82. The white line attribute information 82 is provided to the lane detection unit 48, and the lane detection unit 48 performs a white line detection process by using the white line attribute information 82.

The white line attribute information 82 is information about the attribute of a white line, and is information for distinguishing the shape (a solid line, a broken line, or a double line) of a white line. Also, the white line attribute information 82 is information for distinguishing between a white line and a yellow line (although, as described in the first embodiment, a yellow line is included as a white line for the sake of convenience).

According to the ninth embodiment, accuracy of white line detection by the lane detection unit 48 may be increased. Accordingly, accuracy of autonomous travel control, particularly, autonomous steering control that uses a white line, may be increased.

Additionally, infrastructure attribute information of the magnetic type infrastructure is information about the latitude and the longitude of the installation spot of the magnetic type infrastructure, the shape of arrangement of magnetic markers, or the like. The same thing can be said for the radio wave type infrastructure, the light emission type infrastructure, and the acoustic type infrastructure. Furthermore, infrastructure attribute information of the radio wave infrastructure is information about a used frequency. The same thing can be said for the light emission type infrastructure and the acoustic type infrastructure.

### Tenth Embodiment

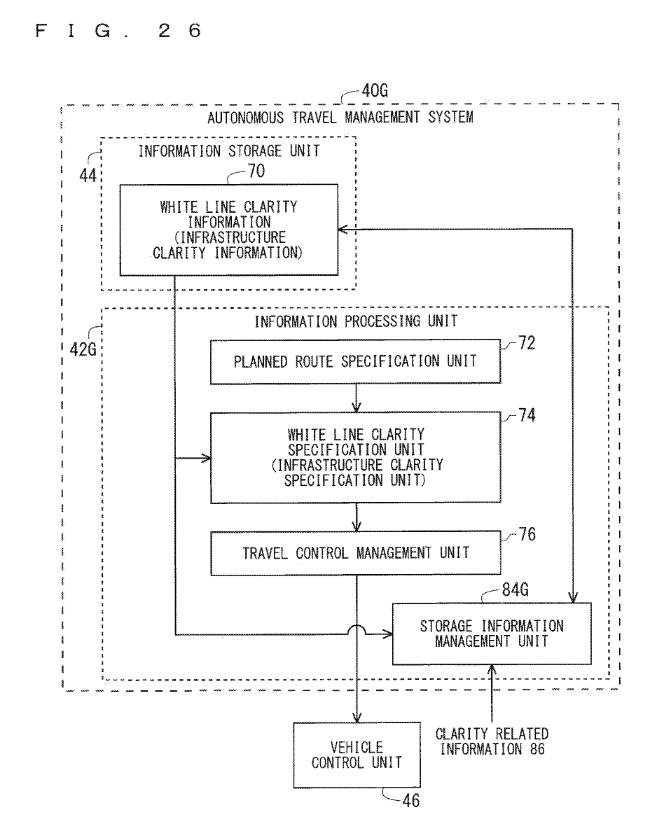

FIG. 24 shows a block diagram of an autonomous travel management system 40F according to a tenth embodiment. The autonomous travel management system 40F may be applied to the autonomous travel control systems 10, 10B described above, instead of the autonomous travel management system 40. The autonomous travel management system 40F includes an information processing unit 42F, and an information storage unit 44F. The information processing unit 42F has the configuration of the information processing unit 42 described above to which a storage information management unit 84 is added.

The information storage unit 44F stores, in addition to the white line clarity information 70 described above, clarity related information 86, which is information related to the white line clarity information. The storage information management unit 84 acquires the clarity related information 86 from outside the autonomous travel management system 40F, and stores the information in the information storage unit 44F. The clarity related information 86 includes at least one of lane detection result information 88 and clarity influencing information 90 (see FIG. 25).

The lane detection result information 88 may be acquired from the lane detection unit 48 of the target vehicle 5. The lane detection result information 88 is the distance where the lane detection unit 48 detected a white line successfully (referred to as a successful detection distance). Alternatively, the lane detection result information 88 may be the proportion of the successful detection distance to a defined distance (for example, 10 meters). Alternatively, the lane detection result information 88 may be the distance where the lane detection unit 48 did not detect a white line (referred to as an unsuccessful detection distance). Also, the lane detection result information 88 may include the accuracy of the information (based on the performance of the lane detection unit 48 and the detected environment).

Information about a spot to which the lane detection result information 88 is related is annexed to the lane detection result information 88, and a road section to which the lane detection result information 88 is related may thereby be specified. Alternatively, the storage information management unit 84 arranges the lane detection result information 88 on a per road section basis based on the annexed spot information, to store the lane detection result information 88 in the information storage unit 44F.

Additionally, the lane detection result information 88 does not have to be information which is detected by using a front camera. That is, the lane detection result information 88 may be acquired also by using a rear camera for parking, for example.

The storage information management unit 84 stores the acquired lane detection result information 88 in the information storage unit 44F only if the lane detection result information 88 satisfies a management standard. The management standard defines that the difference between the acquired lane detection result information 88 and the white line clarity information 70 in the information storage unit 44F is at or above a standard that is set in advance, for example.

Here, the lane detection result information 88 may be information that is obtained by a lane detection system of another vehicle (corresponding to the lane detection unit 48 of the target vehicle 5). That is, the storage information management unit 84 acquires the lane detection result information 88 of an other vehicle 7 (see FIG. 16) via the external communication unit 100 (see FIG. 16). In this case, the reliability of the lane detection result information 88 may be ensured by applying a management standard requiring that the other vehicle 7 be registered in advance.

The lane detection result information 88 is used for the white line clarity specification process. That is, the white line clarity specification unit 74 corrects the white line clarity read from the white line clarity information 70 by the lane detection result information 88 for the same planned section.

The clarity influencing information 90 is information that influences the white line clarity, and is information about an obstruction situation described in the fifth embodiment, for example. As described in the fifth embodiment, the information about an obstruction situation may be acquired from the travel environment detection unit 50 and the external server 102 (see FIG. 16). Information acquired from the external server 102 is stored in the information storage unit 44F on the condition that it meets a management standard (that the server is a reliable server, for example). Like the lane detection result information 88, the clarity influencing information 90 is also stored in the information storage unit 44F in a manner allowing identification of the related road section. The clarity influencing information 90 is used by the travel control management unit 76 for the autonomous travel setting process.

According to the tenth embodiment, autonomous travel control according to the current situation may be realized.

### Eleventh Embodiment

FIG. 26 shows a block diagram of an autonomous travel management system 40G according to an eleventh embodiment. The autonomous travel management system 40G may be applied to the autonomous travel control systems 10, 10B described above, instead of the autonomous travel management system 40. The autonomous travel management system 40G includes an information processing unit 42G according to the eleventh embodiment, and the information storage unit 44 described above. The information processing unit 42G has the configuration of the information processing unit 42 described above to which a storage information management unit 84G is added.

The storage information management unit 84G is basically the same as the storage information management unit 84 according to the tenth embodiment (see FIG. 24). However, the storage information management unit 84G updates the white line clarity information 70 in the information storage unit 44 by using the clarity related information 86 acquired from outside the autonomous travel management system 40G.

According to the eleventh embodiment, as in the tenth embodiment, autonomous travel control according to the current situation may be realized.

### Twelfth Embodiment

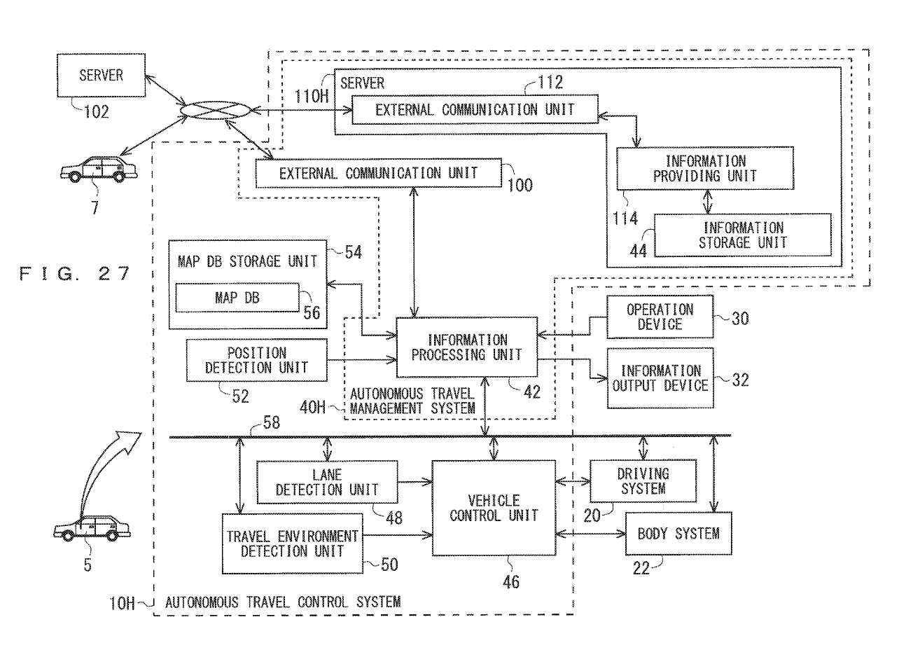

A case has been described above where the entire autonomous travel management system 40 is installed in the target vehicle 5. However, the autonomous travel management system 40 may be partially or entirely provided outside the target vehicle 5. The same thing can be said for other autonomous travel management systems 40B, 40C, 40D, 40E, 40F, 40G. FIGS. 27 to 31 show block diagrams of autonomous travel control systems 10H, 10I, 10J, 10K, 10L according to a twelfth embodiment.

The autonomous travel control system. 10H in FIG. 27 includes the autonomous travel management system 40H. According to the autonomous travel management system 40H, the information processing unit 42 is installed in the target vehicle 5, but the information storage unit 44 is provided to a server 110H.

The server 110H includes, in addition to the information storage unit 44, an external communication unit 112 and an information providing unit 114. The information providing unit 114 acquires a request from the information processing unit 42 provided to the target vehicle 5 via the external communication unit 100 on the target vehicle 5 side and the external communication unit 112 on the server 110H side. Then, in response to the request from the information processing unit 42, the information providing unit 114 reads out at least a part of the white line clarity information 70 in the information storage unit 44, Then, the information providing unit 114 transmits the read-out information to the information processing unit 42 via the external communication unit 112. The information that is transmitted from the external communication unit 112 is acquired by the information processing unit 42 via the external communication unit 100 on the target vehicle 5 side. Additionally, in FIG. 27, the external communication units 100, 112 communicate with each other over the Internet, but the external communication units 100, 112 may alternatively directly communicate with each other by wireless communication.

According to the autonomous travel management system 40H, the same operation as in the first to the fifth embodiments may be realized, and the effects by the operation may be obtained.

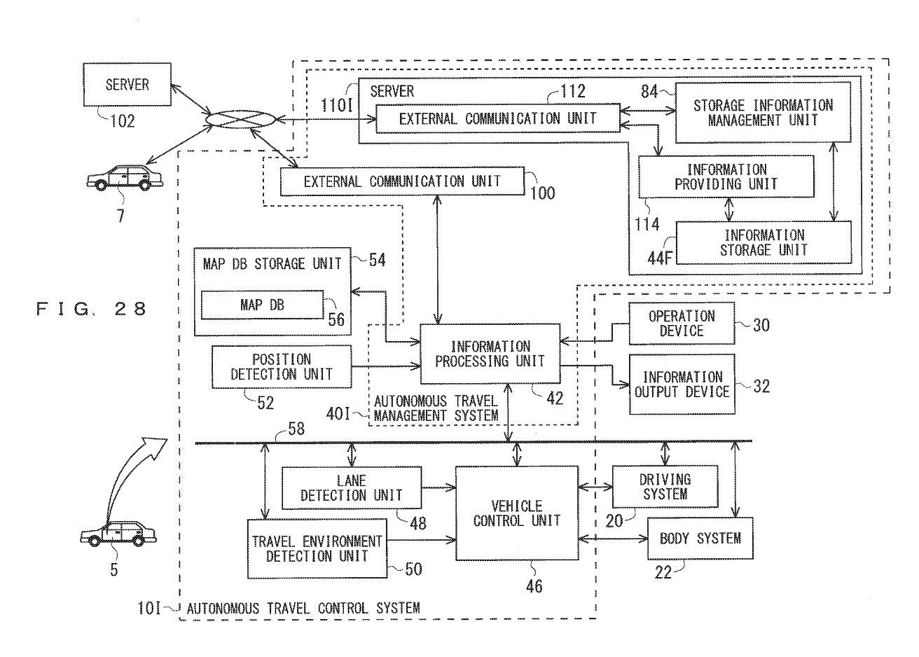

The autonomous travel control system 101 in FIG. 28 includes the autonomous travel management system 40I. According to the autonomous travel management system 40I, the information processing unit 42 is installed in the target vehicle 5, but the information storage unit 44F according to the tenth embodiment is provided to a server 110I. The server 110I includes, in addition to the information storage unit 44F, the external communication unit 112 and the information providing unit 114, the storage information management unit 84 according to the tenth embodiment. Accordingly, the information processing unit 42F according to the tenth embodiment (see FIG. 24) is configured from the information processing unit 42 provided to the target vehicle 5 and the storage information management unit 84 provided to the server 110I. Therefore, according to the autonomous travel management system 40I, the same operation as in the tenth embodiment may be realized, and the effects by the operation may be obtained.

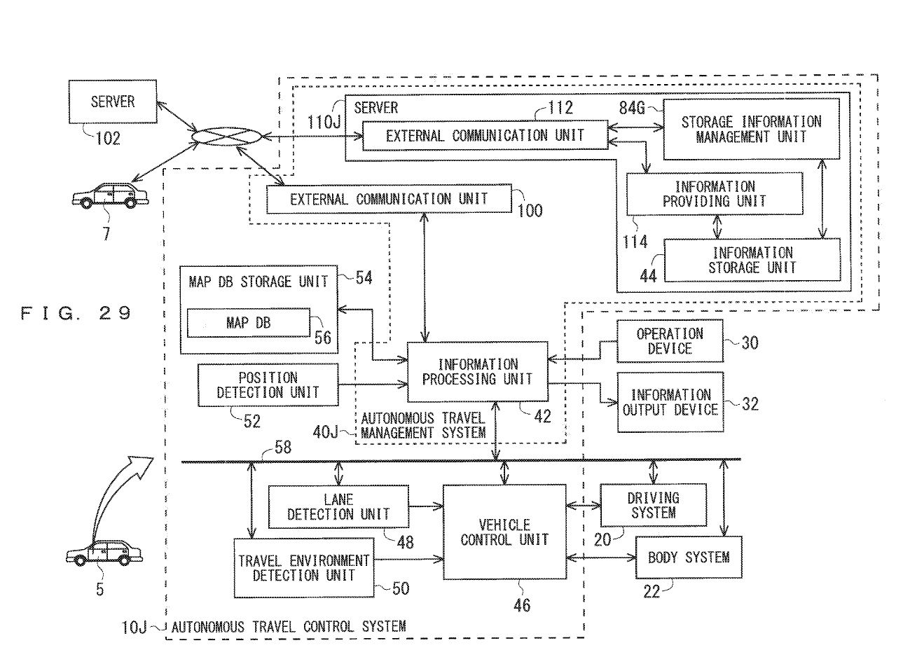

The autonomous travel control system 10J in FIG. 29 includes the autonomous travel management system 40J. According to the autonomous travel management system 40J, the information processing unit 42 is installed in the target vehicle 5, but the information storage unit 44 is provided to a server 110J. The server 110J includes, in addition to the information storage unit 44, the external communication unit 112 and the information providing unit 114, the storage information management unit 84G according to the eleventh embodiment. Accordingly, the information processing unit 42G according to the eleventh embodiment (see FIG. 26) is configured from the information processing unit 42 provided to the target vehicle 5 and the storage information management unit 84G provided to the server 110J. Therefore, according to the autonomous travel management system 40J, the save operation as in the eleventh embodiment may be realized, and the effects by the operation may be obtained.

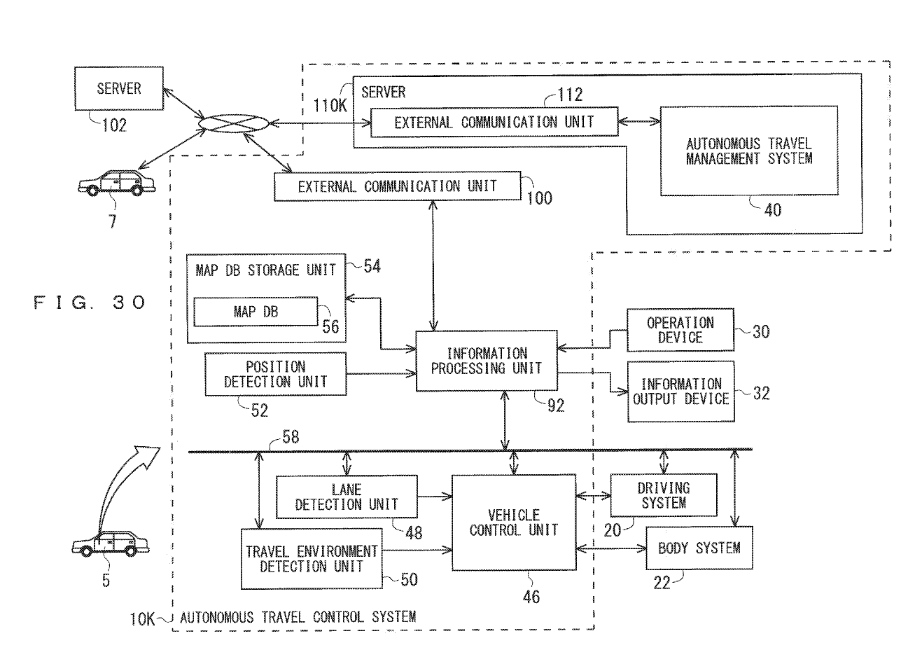

According to the autonomous travel control system 10K in FIG. 30, the autonomous travel management system 40 is provided entirely in a server 110K. Additionally, an information processing unit 92 for controlling a communication function and the like of the target vehicle 5 is provided on the target vehicle 5 side.

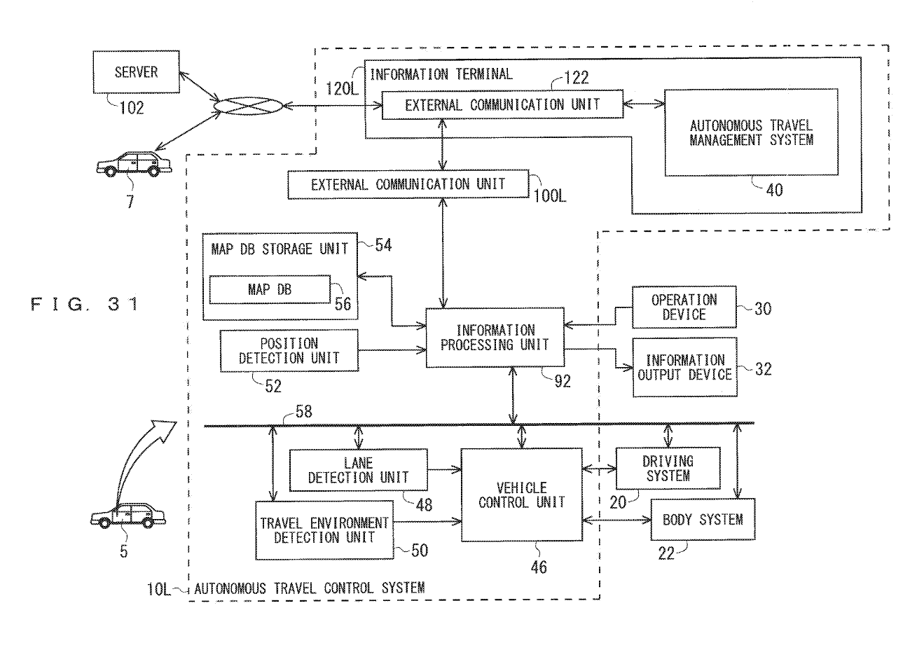

An information terminal may be used as the external communication unit 100 is as described above. When considering this point, it is also possible to install the entire autonomous travel management system 40 in an information terminal 120L, as in the case of the autonomous travel control system 10L in FIG. 31. Additionally, an external communication unit 100L for performing communication with an external communication unit 122 of the information terminal 120L is provided to the target vehicle 5 side. The external communication units 100L, 122 may communicate with each other in a wireless or wired manner.

Furthermore, the structural elements of the autonomous travel management system 40 may be provided, distributed among the target vehicle 5, the server, and the information terminal.

When considering the first to the eleventh embodiments and combinations thereof, the various configurations described above are only examples.

### Example Modifications

The embodiments of the present invention may be freely combined within the scope of the present invention, and modifications and omissions may be made in each embodiment as appropriate.

Detailed description has been given on the present invention, but the description given above is only an example in every aspect, and the present invention is not to be limited by the description. It should be understood that countless unillustrated modifications can fall within the scope of the present invention.

### REFERENCE SIGNS LIST

5 target vehicle of travel control, 7 other vehicle, 10, 10B, 10H, 10I, 10J, 10K, 10L autonomous travel control system, 32 information output device, 40, 40B, 40C, 40D, 40E, 40F, 40G, 40H, 40I, 40J autonomous travel management system, 42, 42C, 42D, 42F, 42G information processing unit, 44, 44E, 44F information storage unit, 48 lane detection unit (lane detection system), 70 white line clarity information (infrastructure clarity information), 72 planned route specification unit, 73 planned travel route, 74 infrastructure clarity specification unit, 76 travel control management unit, 78 notification control unit, 80 map display control unit, 82 infrastructure attribute information, 84, 84G storage information management unit, 86 clarity related information, 88 lane detection result information, 90 clarity influencing information, 110H, 110I, 110J, 110K server, 114 information providing unit, 120L information terminal, LF frequent change section, S12, S23, S33 white line clarity specification process (infrastructure clarity specification process), S13, S24, S34, S44 autonomous travel setting process

1-20. (canceled)

21. An autonomous travel management apparatus comprising:
a planned route specifier to specify a planned travel route for a target vehicle of travel control; and
an information storage to store infrastructure clarity information recording infrastructure clarity that is clarity of a road infrastructure that is used as a detection object by a lane detection apparatus provided to said target vehicle,
wherein said infrastructure clarity information stored in said information storage includes said infrastructure clarity for a plurality of lanes for one-way traffic on a per road section basis, and a road link used in a map database is adopted as said road section, and
the autonomous travel management apparatus comprising:
an infrastructure clarity specifier to perform an infrastructure clarity specification process to specify, based on said infrastructure clarity information, said infrastructure clarity of a planned section that is said road section included in said planned travel route; and
a travel control manager to perform an autonomous travel setting process to set control contents of autonomous travel in said planned travel route based on said infrastructure clarity of said planned section, and to perform said autonomous travel setting process according to an autonomy level condition by which control contents at a higher level are selected among a plurality of autonomy levels as said infrastructure clarity becomes higher.

22. The autonomous travel management apparatus according to claim 21, wherein said travel control manager performs said autonomous travel setting process according to an autonomous steering condition by which control contents including autonomous steering control that uses said lane detection apparatus are selected for said planned section where said infrastructure clarity satisfies an autonomous steering standard.

23. The autonomous travel management apparatus according to claim 22, wherein said travel control manager performs said autonomous travel setting process according to an autonomous steering level condition by which control contents including autonomous steering control at a higher level are selected as said infrastructure clarity becomes higher.

24. The autonomous travel management apparatus according to claim 21, wherein said autonomy level condition includes a condition by which said autonomy level becomes higher as said control contents include a greater number of types of control selected among inter-vehicle distance control, constant speed traveling control, lane keeping control, and passing control.

25. The autonomous travel management apparatus according to claim 24, wherein said plurality of autonomy levels include at least two among
a first level that is assigned with said inter-vehicle distance control and said constant speed traveling control,
a second level that is assigned with said inter-vehicle distance control, said constant speed traveling control, and said lane keeping control, and that is a level higher than said first level, and
a third level that is assigned with said inter-vehicle distance control, said constant speed traveling control, said lane keeping control, and said passing control, and that is a level higher than said first and second levels,
said infrastructure clarity includes, as white line clarity, a white line distance that is a distance of a white line that can be continuously detected by said lane detection apparatus, and
said passing control at said third level is selected in a case where said white line distance in a passing lane is equal to or greater than a predetermined value in front of said target vehicle.

26. The autonomous travel management apparatus according to claim 21, wherein,
said infrastructure clarity includes, as white line clarity, a white line distance that is a distance of a white line that can be continuously detected by said lane detection apparatus, and
in a case where selected control contents include constant speed traveling control, said travel control manager sets a higher constant speed to be applied in said constant speed traveling control as said white line distance becomes lower.

27. The autonomous travel management apparatus according to claim 21, wherein,
said infrastructure clarity includes, as white line clarity, a white line distance that is a distance of a white line that can be continuously detected by said lane detection apparatus, and
in a case where said white line clarity is to be reduced due to entrance from a first planned section into a second planned section and where a detection range of said lane detection apparatus in said first planned section is given as Srange [m], said white line clarity of said second planned section is given as Ldd [m], and a distance from a current position of said target vehicle in said first planned section to a start spot of said second planned section is given as D [m], said travel control manager starts said control contents for said second planned section before a timing of establishment of D=Srange−Ldd.

28. The autonomous travel management apparatus according to claim 21, wherein, in a case where there is a frequent change section where said infrastructure clarity changes at a frequency equal to or more than a defined frequency, said travel control manager applies said control contents that are based on lowest infrastructure clarity in said frequent change section to an entire section of said frequent change section.

29. The autonomous travel management apparatus according to claim 21, wherein said travel control manager sets said control contents based also on information about an obstruction situation that is a situation that is an obstruction to execution of said control contents.

30. The autonomous travel management apparatus according to claim 21, further comprising a map display controller to set a display form of said planned section in a map image according to said autonomy level of said planned section, and to cause a display to display said map image.

31. The autonomous travel management apparatus according to claim 21, wherein,
in a case where a plurality of planned travel routes are found by said planned route specifier, said infrastructure clarity specifier performs said infrastructure clarity specification process for each planned travel route, and
said travel control manager performs said autonomous travel setting process on said each planned travel route, calculates a cost of traveling said each planned travel route based on results of said autonomous travel setting process, and selects one planned travel route for which said cost is lowest, or performs said autonomous travel setting process on one planned travel route for which a change in said infrastructure clarity is smallest.

32. The autonomous travel management apparatus according to claim 21, further comprising a storage information manager to acquire clarity related information related to said infrastructure clarity information, and to store said clarity related information in said information storage.

33. The autonomous travel management apparatus according to claim 21, further comprising a storage information manager to acquire clarity related information related to said infrastructure clarity information, and to update said infrastructure clarity information in said information storage by using said clarity related information.

34. The autonomous travel management apparatus according to claim 21, wherein said information storage is provided to a server, and said infrastructure clarity specifier is provided to said target vehicle.

35. The autonomous travel management apparatus according to claim 21, wherein said road infrastructure is one of
a magnetic type infrastructure that generates magnetism,
a radio wave type infrastructure that emits radio waves,
a light emission type infrastructure that emits light, and
an acoustic type infrastructure that emits sound.

36. The autonomous travel management apparatus according to claim 21, wherein said infrastructure clarity includes, as white line clarity, a white line distance that is a distance of a white line that can be continuously detected by said lane detection apparatus.

37. The autonomous travel management apparatus according to claim 21, wherein said information storage further stores infrastructure attribute information about an attribute of said road infrastructure, said infrastructure attribute information includes white line attribute information about an attribute of a white line, and said white line attribute information includes information to distinguish a shape of a white line, and information to distinguish between a white line and a yellow line.

38. The autonomous travel management apparatus according to claim 21, wherein said road infrastructure is installed on a wall along a road.

39. A server comprising:
an external communicator to perform communication with outside the server;
an information storage to store infrastructure clarity information recording infrastructure clarity that is clarity of a road infrastructure that is used as a detection object by a lane detection apparatus provided to a target vehicle of travel control; and
wherein said infrastructure clarity information stored in said information storage includes said infrastructure clarity for a plurality of lanes for one-way traffic on a per road section basis, and a road link used in a map database is adopted as said road section, and
an information processor provided to said target vehicle performs an infrastructure clarity specification process to specify, based on said infrastructure clarity information, said infrastructure clarity of a planned section that is said road section included in a planned travel route, and performs an autonomous travel setting process to set control contents of autonomous travel in said planned travel route based on said infrastructure clarity of said planned section, and performs said autonomous travel setting process according to an autonomy level condition by which control contents at a higher level are selected among a plurality of autonomy levels as said infrastructure clarity becomes higher, and
the server comprising:
an information provider to acquire an information provision request from said information processor provided to said target vehicle via said external communicator, and to provide at least a part of said infrastructure clarity information requested by said information provision request to said information processor via said external communicator.

40. The server according to claim 39, wherein said information storage further stores infrastructure attribute information about an attribute of said road infrastructure, and said information provider provides at least a part of said infrastructure attribute information requested by said information provision request to said information processor via said external communicator.

41. The server according to claim 39, further comprising a storage information manager to receive clarity related information related to said infrastructure clarity information via said external communicator, and to store said clarity related information that is received in said information storage.

42. The server according to claim 39, further comprising a storage information manager to receive clarity related information related to said infrastructure clarity information via said external communicator, and to update said infrastructure clarity information in said information storage by using said clarity related information that is received.

43. An autonomous travel management method comprising:
specifying a planned travel route for a target vehicle of travel control; and
performing an infrastructure clarity specification process to specify, based on infrastructure clarity information, infrastructure clarity of a planned section that is a road section included in said planned travel route,
wherein said infrastructure clarity is clarity of a road infrastructure that is used as a detection object by a lane detection apparatus provided to said target vehicle, and said infrastructure clarity information is information recording said infrastructure clarity for a plurality of lanes for one-way traffic on a per road section basis, and a road link used in a map database is adopted as said road section, and
the autonomous travel management method comprising:
performing an autonomous travel setting process to set control contents of autonomous travel in said planned travel route based on said infrastructure clarity of said planned section, and performing said autonomous travel setting process according to an autonomy level condition by which control contents at a higher level are selected among a plurality of autonomy levels as said infrastructure clarity becomes higher.
